(19) United States
(12) Patent Application Publication
(10) Pub. No.: US 2014/0083042 A1
(43) Pub. Date: Mar. 27, 2014

(54) JUNCTION STRUCTURE BETWEEN STRUCTURES AND BEAM JUNCTION METHOD

(71) Applicant: BEST NATURE CO., LTD., Shizuoka-shi (JP)

(72) Inventor: Shigeru HIRAGAKI, Shizuoka-shi (JP)

(73) Assignee: BEST NATURE CO., LTD., Shizuoka-shi (JP)

(21) Appl. No.: 13/628,823

(22) Filed: Sep. 27, 2012

(51) Int. Cl. F16B 17/00; E04B 1/41

(52) U.S. Cl. CPC F16B 17/002; E04B 1/40
USPC 52/655.1; 52/745.21

(57) ABSTRACT

In a junction structure between structures formed by connecting a hollow rectangular beam having a rectangular cross section between a first column and a first′ column, the beam has a first beam, a second beam, and a first′ beam from the first column toward the first′ column. Three surfaces other than an upper surface of the first beam and three surfaces other than an upper surface of the second beam are sandwiched between plates from inner and outer sides and joined together with bolts, and the upper surfaces are joined to each other by welding contact portions of an upper portion of the first beam and an upper portion of the second beam. Three surfaces other than an upper surface of the first′ beam and the three surfaces other than the upper surface of the second beam are sandwiched between plates from inner and outer sides and joined together with bolts, and the upper surfaces are joined to each other by welding contact portions of an upper portion of the first′ beam and the upper portion of the second beam.

### TECHNICAL FIELD

The present invention relates to a junction structure between structures and a beam junction method, and in particular, to a junction structure between structures and a beam junction method by bolt junction, which have a high strength, use less welding, and can improve workability at a high altitude.

### BACKGROUND ART

Conventionally, beams have been joined together with a bolt via a plate (Refer to, for example, Patent document 1).

The H-steel beams can be joined together with the bolt via the plate. However, the H-steel beams have a larger height than rectangular beams having a rectangular cross section, resulting in weaker bending strength.

### PRIOR ART DOCUMENTS

### Patent Document

Patent Document 1: Japanese Patent Laid-open Publication No. 2005-299130

### SUMMARY OF THE INVENTION

### Problems to be Solved by the Invention

However, for the rectangular beams having a rectangular cross section, friction joining using the bolt is difficult, therefore, welding was required. However, welding takes time and effort and further, accompanies work at a high altitude, which is dangerous.

In consideration of the above-mentioned problems, the present invention provides a junction structure between structures and a beam junction method, having a high strength, enabling friction joining using a bolt, using less welding, and improving workability at a high altitude.

In a junction structure between structures according to the present invention, by providing an inclined portion of a first beam inclined at A degrees (A<90), an inclined portion of a second beam inclined at B degrees (180 degrees−A degrees), an inclined portion of the first′ beam inclined at A degrees (A<90), and an inclined portion of the second beam inclined at B degrees (180 degrees−A degrees), three surfaces other than an upper surface of the first beam can be joined to respective three surfaces other than an upper surface of the second beam by being sandwiched between plates from inner and outer sides and joined together with bolts and nuts in this state, and the upper surfaces can be joined to each other by welding. As a result, the junction structure that has a high strength, uses less welding as compared to the junction structure between structures having four welded surfaces, and improves workability at a high altitude, can be realized.

In the junction structure between structures according to the present invention, by providing the inclined portion of the first beam inclined at A degrees (A<90) and the inclined portion of the second beam inclined at B degrees (180 degrees−A degrees), three surfaces other than an upper surface of the first beam can be joined to respective three surfaces other than an upper surface of the second beam by being sandwiched between plates from inner and outer sides and joined together with bolts and nuts, and the upper surfaces can be joined by welding. Thus, the junction structure between structures that has a high strength, uses less welding as compared to the junction structure between structures having four welded surfaces, and improves workability at a high altitude can be realized.

According to a beam junction method of the present invention, by providing the inclined portion of the first beam inclined at A degrees (A<90) and the inclined portion of the second beam inclined at B degrees (180 degrees−A degrees), three surfaces other than an upper surface of the first beam can be joined to respective three surfaces other than an upper surface of the second beam by being sandwiched by a first inner front plate, a first outer front plate, a first inner back plate, a first outer back plate, a first inner bottom plate, and a first outer bottom plate from inner and outer sides and joined together with bolts and nuts, and the upper surfaces can be joined by welding. Thus, the junction structure between structures that has a high strength, uses less welding as compared to the junction structure between structures having four welded surfaces, and improves workability at a high altitude can be realized.

### BRIEF DESCRIPTION OF DRAWINGS

FIG. 1 is a schematic front view of a junction structure between structures in an embodiment of the present invention.

FIG. 2 is a schematic front view showing a state before connection of a second beam of the junction structure between structures in FIG. 1.

FIG. 3 is a schematic perspective view schematically showing FIG. 2.

FIG. 4 is a schematic perspective view schematically showing relationship between a first beam and a second beam in FIG. 3.

FIG. 5 is a schematic perspective view schematically showing relationship between the second beam and a first′ beam in FIG. 3.

FIG. 6 is a schematic partial enlarged front view showing a part of FIG. 1.

FIG. 7 is a schematic sectional view in FIG. 6.

FIG. 8 is a schematic sectional view taken along a line 8-8 in FIG. 6.

FIG. 9 is a schematic perspective view of a bolt vertically arranged in the beam for use.

FIG. 10 is a schematic front view showing a state prior to connection in FIG. 6.

FIG. 11 is a schematic view for describing positional relationship between holes provided in a bottom portion of the first beam and holes provided in a bottom portion of the second beam in FIG. 10.

FIG. 12 is a schematic sectional view taken along a line 12-12 in FIG. 10.

FIG. 13 is a schematic sectional view taken along a line 13-13 in FIG. 10.

FIG. 14 is a schematic view for describing positional relationship among holes provided in a front portion of the first beam, a front portion of the second beam, a first outer front plate, and a first inner front plate in FIG. 12.

FIG. 15 is a schematic view for describing positional relationship among holes provided in a back portion of the first beam, a back portion of the second beam, a first outer back plate, and a first inner back plate in FIG. 12.

FIG. 16 is a schematic front sectional view showing the bottom portion of the first beam and the bottom portion of the second beam in FIG. 6.

FIG. 17 is a schematic plan sectional view showing a connected state of the first beam and the second beam in FIG. 6.

FIG. 18 is a schematic partial enlarged front view showing a part of FIG. 1.

FIG. 19 is a schematic sectional view of FIG. 18.

FIG. 20 is a schematic sectional view taken along a line 20-20 in FIG. 18.

FIG. 21 is a schematic front view showing a state prior to connection in FIG. 18.

FIG. 22 is a schematic sectional view taken along a line 22-22 in FIG. 21.

FIG. 23 is a schematic sectional view taken along a line 23-23 in FIG. 21.

FIG. 24 is a schematic front sectional view showing a connected state of the bottom portion of the first beam and the bottom portion of the second beam in FIG. 18.

FIG. 25 is a schematic plan sectional view showing a connected state of the first beam and the second beam in FIG. 18.

FIG. 26 is a schematic view for describing positional relationship among holes provided in a front portion of the first′ beam, a front portion of the second beam, a first′ outer front plate, and a first′ inner front plate in FIG. 25.

FIG. 27 is a schematic view for describing positional relationship among holes provided in a back portion of the first′ beam, a back portion of the second beam, a first′ outer back plate, and a first′ inner back plate in FIG. 25.

FIG. 28 is a schematic view for describing positional relationship among holes provided in a bottom portion of the first′ beam and the bottom portion of the second beam in FIG. 21.

FIG. 29 is a schematic exploded perspective view showing a junction structure between structures in accordance with an embodiment that is different from that in FIG. 1.

FIG. 30 is a schematic front view showing a part of FIG. 29.

FIG. 31 is schematic plan sectional view showing a connected state of the first beam and the second beam in FIG. 29.

FIG. 32 is a schematic view for describing positional relationship among holes provided in the front portion of the first beam, the front portion of the second beam, the first outer front plate, and the first inner front plate in FIG. 31.

FIG. 33 is a schematic view for describing positional relationship among holes provided in the back portion of the first beam, the back portion of the second beam, the first outer back plate, and the first inner back plate in FIG. 31.

FIG. 34 is a schematic front view showing a part in FIG. 29.

FIG. 35 is a schematic plan sectional view showing a connected state of the first′ beam and the second beam in FIG. 34.

FIG. 36 is a schematic view for describing positional relationship among holes provided in the front portion of the first′ beam, the front portion of the second beam, the first′ outer front plate, and the first′ inner front plate in FIG. 35.

FIG. 37 is a schematic view for describing positional relationship among holes provided in the back portion of the first′ beam, the back portion of the second beam, the first′ outer back plate, and the first′ inner back plate in FIG. 35.

### EMBODIMENTS OF THE INVENTION

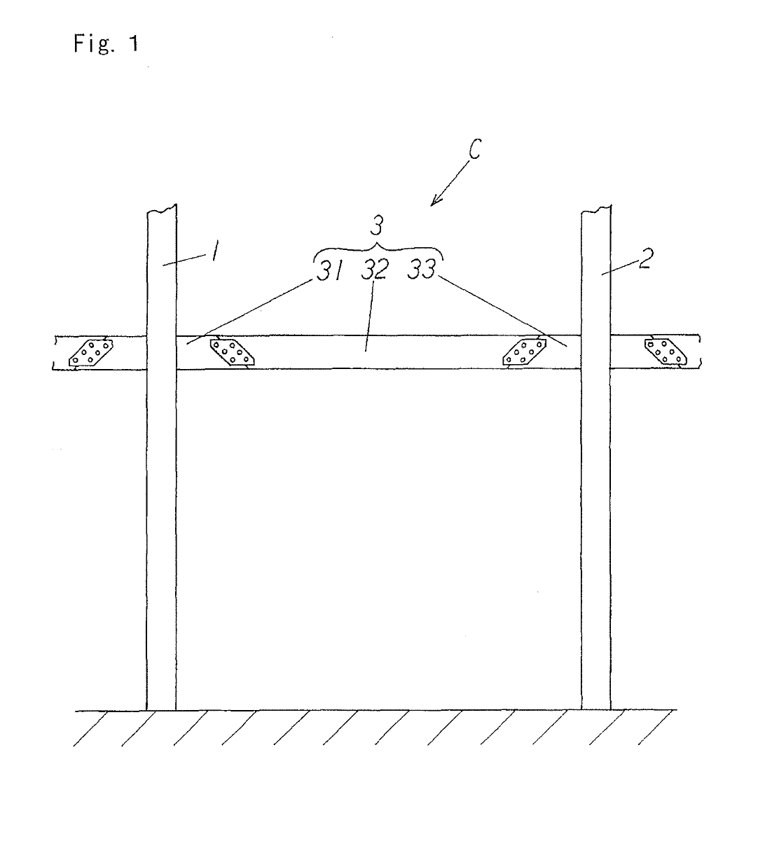

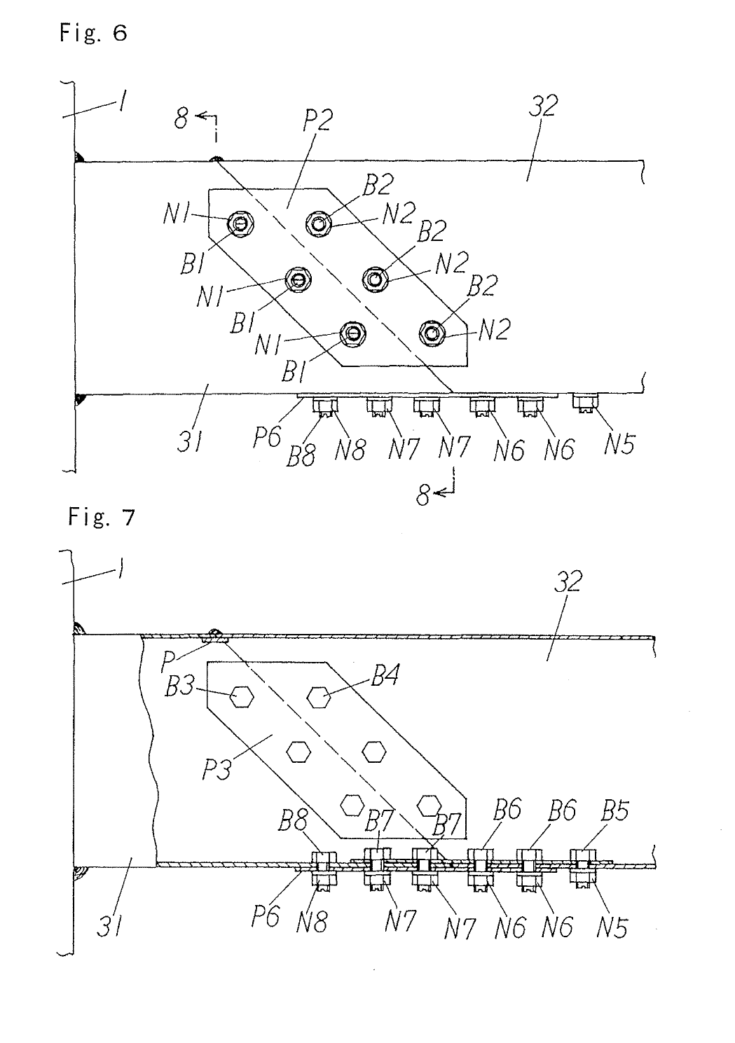

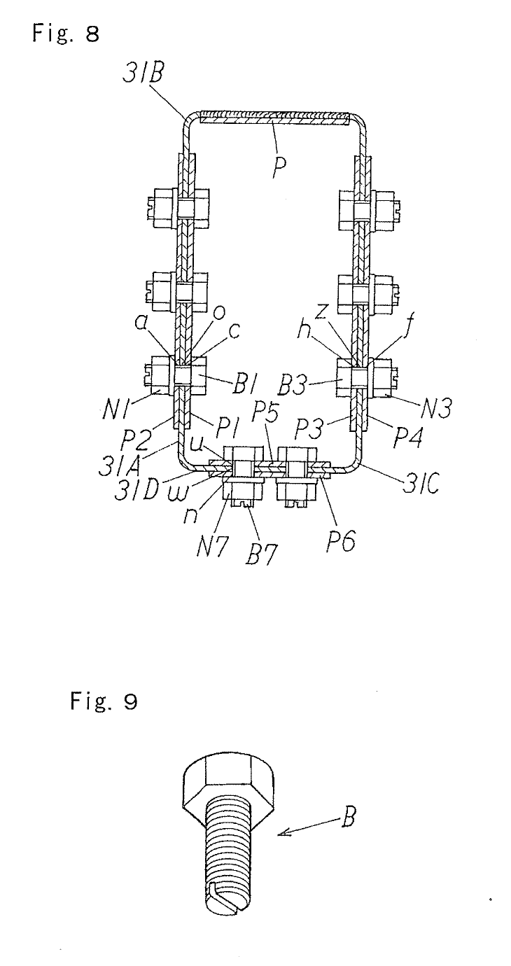

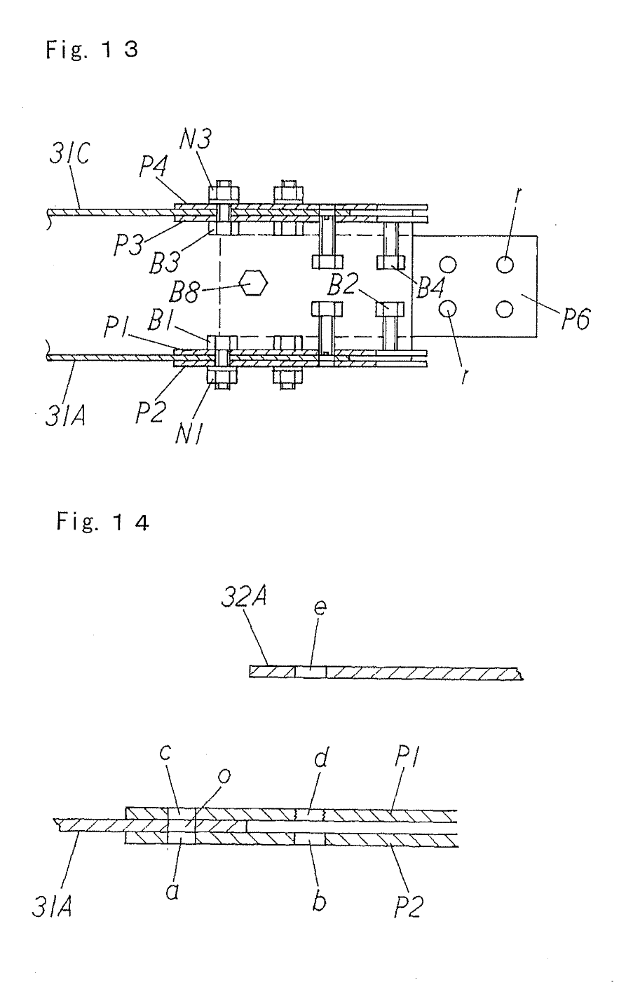

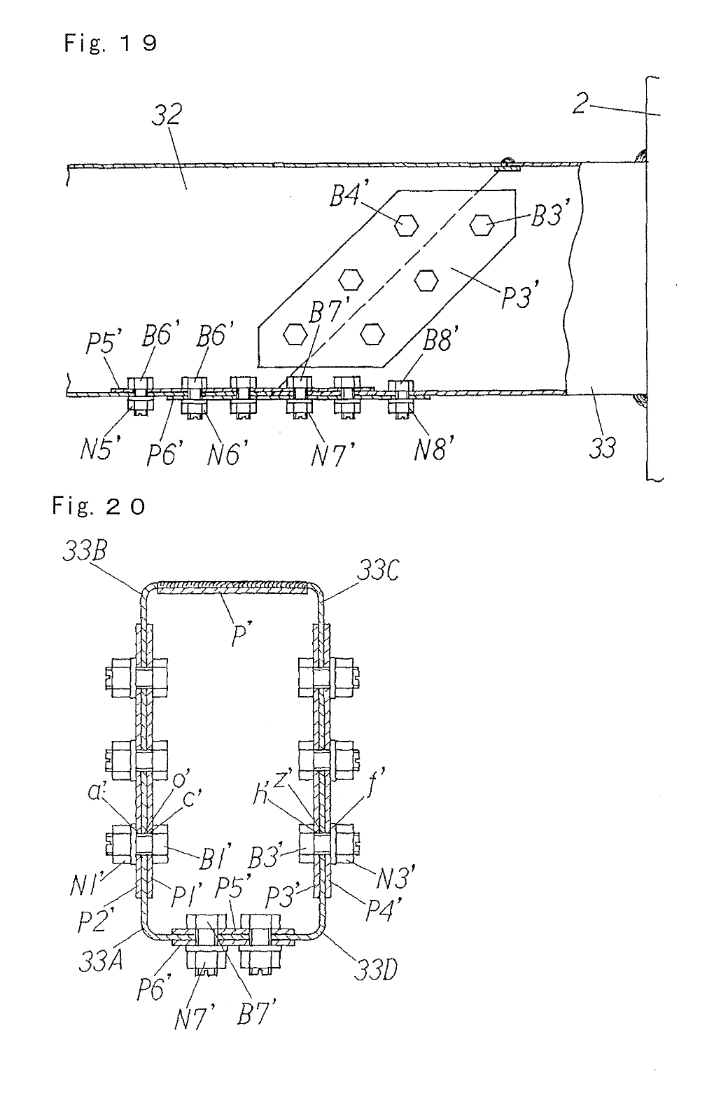

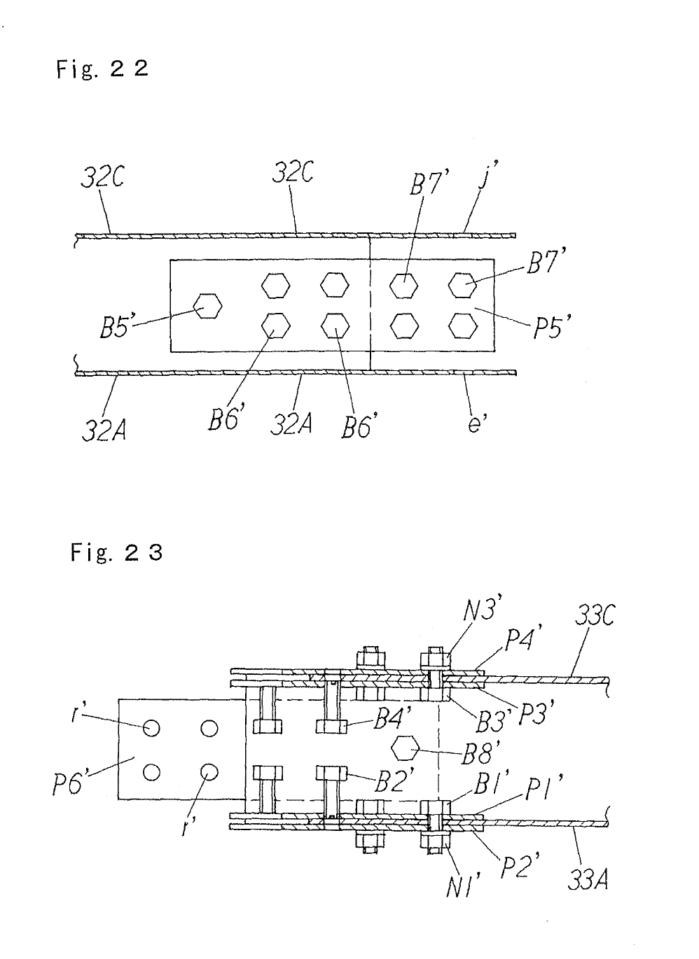

A junction structure between structures and a beam junction method in accordance with an embodiment of the present invention will be described with reference to FIG. 1 to FIG. 28.

A junction structure C between structures shown in FIG. 1 is formed by connecting a rectangular beam 3 having a rectangular cross section between a first column 1 and a first′ column 2.

The beam 3 has a first beam 31, a second beam 32, and a first′ beam 33 from the first column 1 toward the first′ column 2.

The first column 1 and the first beam 31, and the first′ column 2 and the first′ beam 33 are previously connected to each other by welding or the like, on the ground, not at a high altitude.

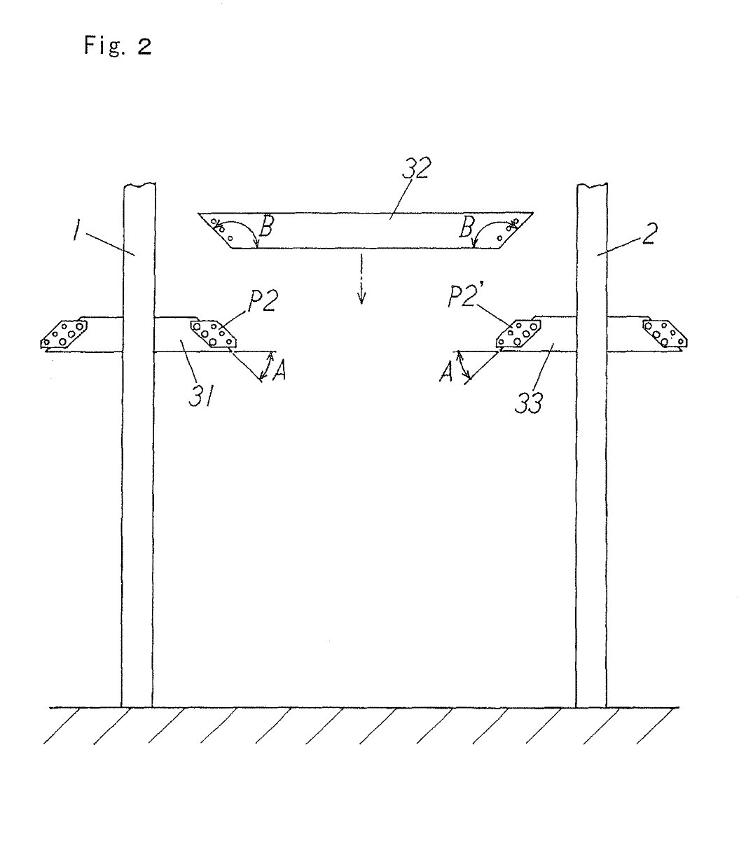

As shown in FIG. 2, the first beam 31 has a substantially trapezoidal shape having its lower base that is longer than its upper base when viewed from the front. An angle that an inclined portion of the first beam 31 on the side of the first column 1 forms with the lower base is 90 degrees, and an angle that an inclined portion of the first beam 31 on the side of the first′ column 2 forms with the lower base is A degrees (A<90).

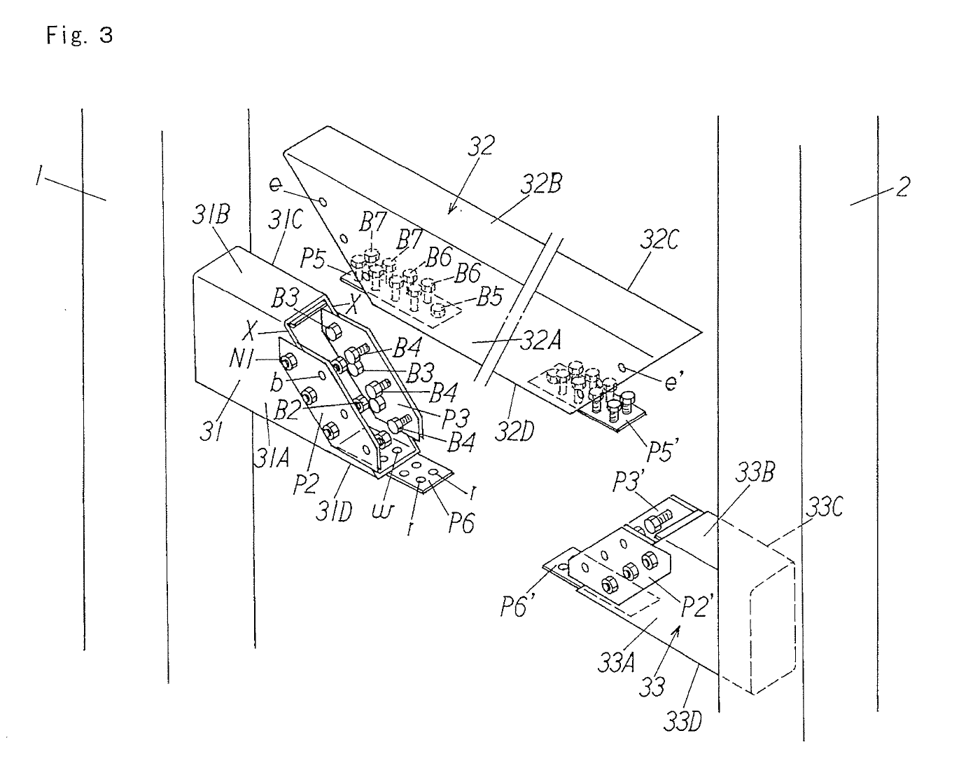

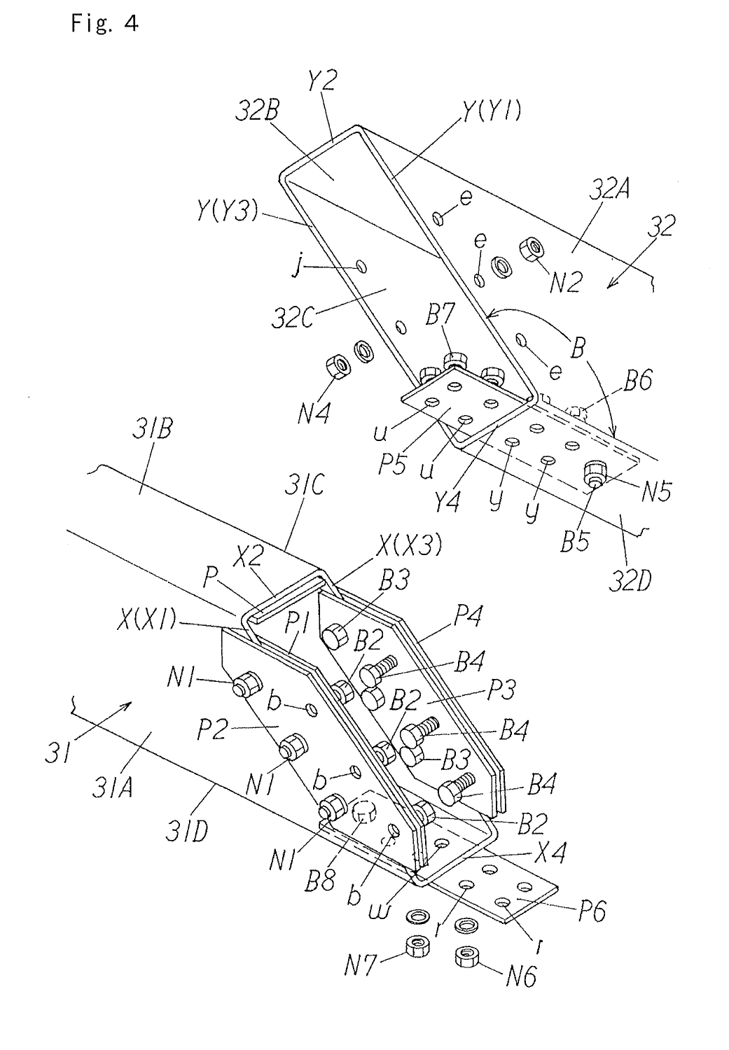

That is, as shown in FIG. 3 and FIG. 4, the first beam 31 has a front portion 31A of the first beam 31, an upper portion 31B of the first beam 31, a back portion 31C of the first beam 31, and a bottom portion 31D of the first beam 31 when viewed from the front. On an end surface of the first beam 31 on the opposite side of the first column 1, when viewed from the above, the bottom portion 31D of the first beam 31 protrudes from the upper portion 31B of the first beam 31 toward the first′ column 2. The front portion 31A of the first beam 31 and the back portion 31C of the first beam 31 form a first inclined surface X inclined at the same angle A so as to decline toward the first′ column 2 in a horizontal direction.

The above-mentioned angle A is smaller than 90 degrees, and practically, in the range of about 30 degrees to about 60 degrees, more desirably, 45 degrees.

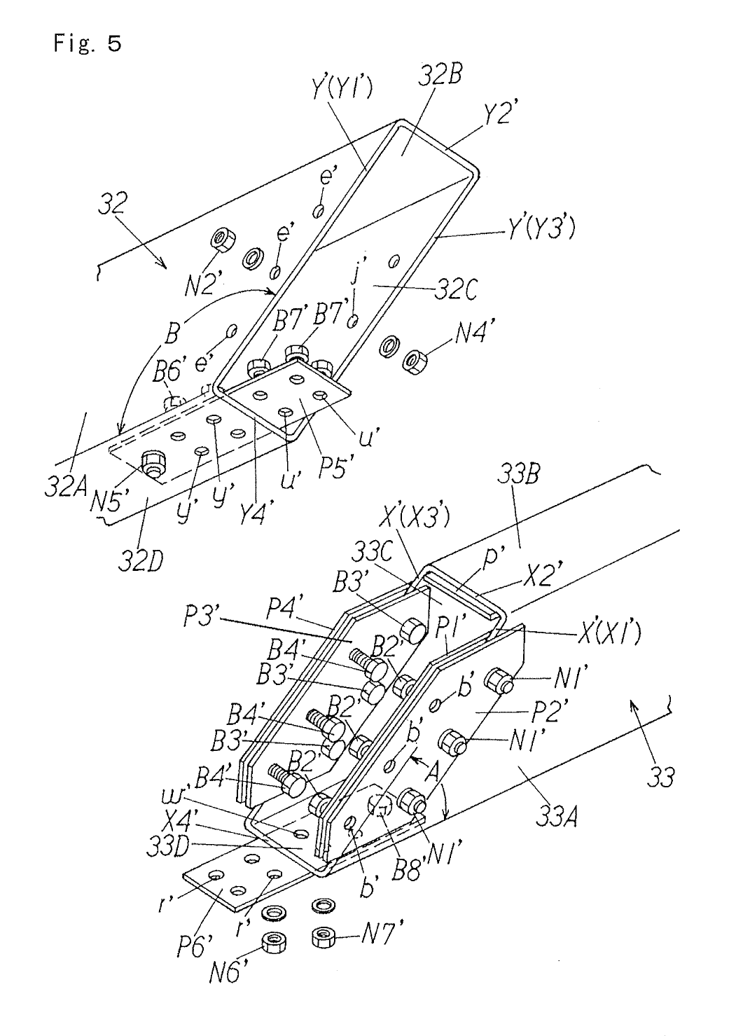

As shown in FIG. 2, FIG. 3, FIG. 4 and FIG. 5, the second beam 32 has a substantially trapezoidal shape having its upper base that is longer than its lower base when viewed from the front. An angle that an inclined portion Y of the second beam 32 on the side of the first column 1 forms with the lower base is B degrees (180 degrees−A degrees), and an angle that an inclined portion Y′ of the second beam 32 on the side of the first′ column 2 forms with the lower base is B degrees (180 degrees−A degrees).

That is, the second beam 32 has a second front portion 32A, a second upper portion 32B, a second back portion 32C, and a second bottom portion 32D when viewed from the front. On an end surface of the second beam 32 toward the first column when viewed from the above, the upper portion 32B of the second beam 32 protrudes from the bottom portion 32D of the second beam 32 toward the first column 1. The front portion 32A of the second beam 32 and the back portion 32C of the second beam 32 on the side of the first column 1 forms a second inclined surface Y inclined at the same angle B (180 degrees−A degrees) so as to incline toward the first column 1 in the horizontal direction. On an end surface of the second beam 32 toward the first′ column 2, when viewed from the above, the upper portion 32B of the second beam 32 protrudes from the bottom portion 32D of the second beam 32 toward the first′ column 2, and the front portion 32A of the second beam 32 and the back portion 32C of the second beam 32 on the side of the first′ column 2 form a second′ inclined surface Y′ inclined at the same angle B so as to incline toward the first′ column 2 in the horizontal direction.

The first′ beam 33 has a substantially trapezoidal shape having its lower base that is longer than its upper base when viewed from the front. An angle that an inclined portion of the first′ beam 33 on the side of the first′ column 2 forms the lower base is 90 degrees, and an angle that an inclined portion X′ of the first′ beam 33 on the side of the first column 1 forms with the lower base is A degrees.

That is, the first′ beam 33 has a front portion 33A of the first′ beam 33, an upper portion 33B of the first′ beam 33, a back portion 33C of the first′ beam 33, and a bottom portion 33D of the first′ beam 33 when viewed from the front. On an end surface of the first′ beam 33 on the opposite side of the first′ column 2, when viewed from the above, the bottom portion 33D of the first′ beam 33 protrudes from the upper portion 33B of the first′ beam 33 toward the first column 1. The front portion 33A of the first′ beam 33 and the back portion 33C of the first′ beam 33 form a first′ inclined surface X′ inclined at the same angle A so as to decline toward the first column 1 in the horizontal direction.

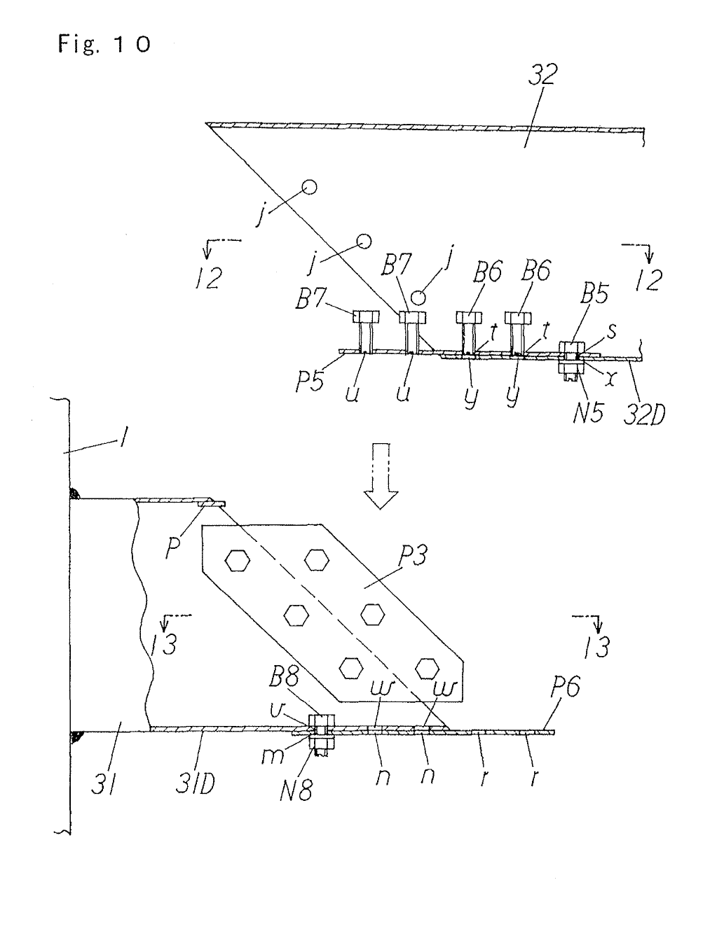

As shown in FIG. 4, FIG. 10 and FIG. 16, an end surface X1 of the front portion 31A of the first beam 31 toward the second beam 32 contacts with an end surface Y1 of the front portion 32 of the second beam 32 toward the first column 1. An end surface X2 of the upper portion 31B of the first beam 31 toward the second beam 32 contacts with an end surface Y2 of the upper portion 32B of the second beam 32 toward the first column 1. An end surface X3 of the back portion 31C of the first beam 31 toward the second beam 32 contacts with an end surface Y3 of the back portion 32C of the second beam 32 toward the first column 1 end surface Y3. An end surface X4 of the bottom portion 31D of the first beam 31 toward the second beam 32 contacts with an end surface Y4 of the bottom portion 32D of the second beam 32 toward the first column 1.

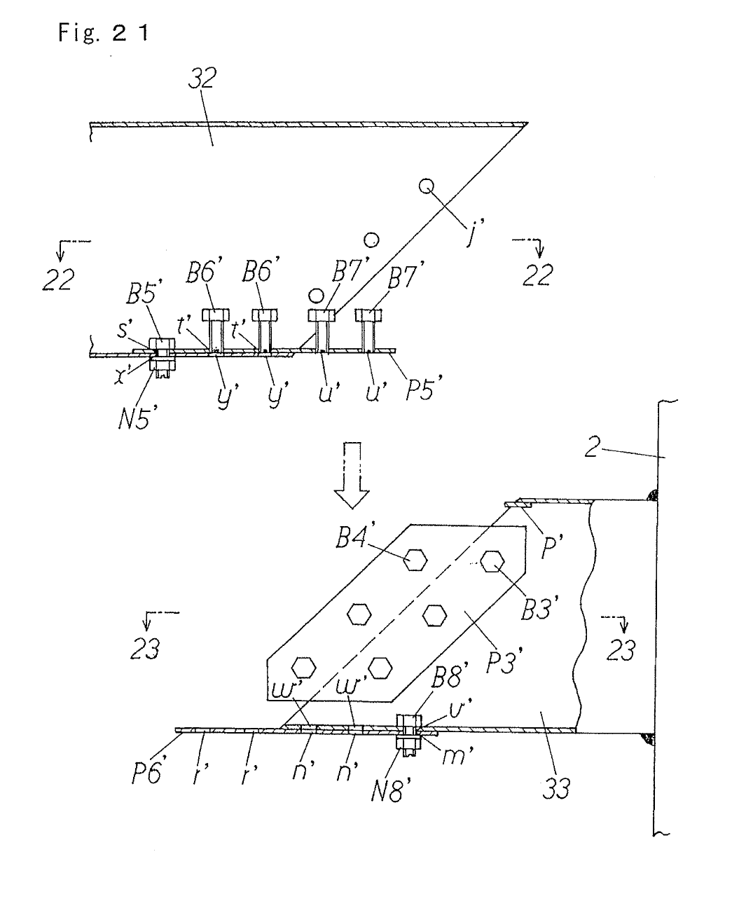

As shown in FIG. 5, FIG. 18 and FIG. 21, an end surface X1′ of the front portion 33A of the first′ beam 33 toward the second beam 32 contacts with an end surface Y1′ of the front portion 32A of the second beam 32 toward the first′ column 2. An end surface X2′ of the upper portion 33B of the first′ beam 33 toward the second beam 32 contacts with an end surface Y2′ of the upper portion 32B of the second beam 32 toward the first′ column 2. An end surface X3′ of the back portion 33C of the first′ beam 33 toward the second beam 32 contacts with an end surface Y3′ of the back portion 32C of the second beam 32 toward the first′ column 2, and an end surface X4′ of the bottom portion 33D of the first′ beam 33 toward the second beam 32, and contacts with an end surface Y4′ of the bottom portion 32D of the second beam 32 toward the first′ column 2.

Three surfaces other than an upper surface of the first beam 31 are joined to respective three surfaces other than an upper surface of the second beam 32 by being sandwiched between plates (P1 to P6) from inner and outer side and joined together with bolts (B1 to B8) and nuts (N1 to N8), which will be described later in detail and the upper surfaces are joined to each other by welding contact portions of the upper portion 31B of the first beam 31 and the upper portion 32B of the second beam 32 together. Three surfaces other than an upper surface of the first′ beam 33 are joined to respective three surfaces other than an upper surface of the second beam 32 by being sandwiched between plates (P1′ to P6′) from inner and outer side and joined together with nuts (N1′ to N8′), which will be described later in detail, and the upper surfaces are joined to each other by welding contact portions of the upper portion 33B of the first′ beam 33 and the upper portion 32B of the second beam 32.

That is, the front portion 31A of the first beam 31 and the front portion 32A of the second beam 32 are joined to each other by being sandwiched between a first inner front plate P1 that is located on the inner side of the beam 3 (31, 32) and extends over the front portion 31A of the first beam 31 and the front portion 32A of the second beam 32 and a first outer front plate P2 that is located on the outer side of the beam 3 (31, 32) and extends over the front portion 31A of the first beam 31 and the front portion 32A of the second beam 32, and joined with the bolts (B1 to B2) and the nuts (N1 to N2).

The back portion 31C of the first beam 31 and the back portion 32C of the second beam 32 are joined to each other by being sandwiched between a first inner back plate P3 that is located on the inner side of the beam 3 (31, 32) and extends over the back portion 31C of the first beam 31 and the back portion 32C of the second beam 32 and a first outer back plate P4 that is located on the outer side of the beam 3 (31, 32) and extends over the back portion 31C of the first beam 31 and the back portion 32C of the second beam 32, and joined with the bolts (B3 to B4) and the nuts (N3 to N4).

The bottom portion 31D of the first beam 31 and the bottom portion 32D of the second beam 32 are joined to each other by being sandwiched between a first inner bottom plate P5 that is located on the inner side of the beam 3 (31, 32) and extends over the bottom portion 31D of the first beam 31 and the bottom portion 32D of the second beam 32 and a first outer bottom plate P6 that is located on the outer side of the beam 3 (31, 32) and extends over the bottom portion 31D of the first beam 31 and the bottom portion 32D of the second beam 32, and joined with the bolts (B5 to B8) and the nuts (N5 to N8).

Contact portions (X2, Y2) of the first upper portion 31B and the second upper portion 32B are joined to each other by welding. P is a plate provided on the inner side so as to extend over joined portions of the first upper portion 31B and the second upper portion 32B (FIG. 4, FIG. 10 and FIG. 14).

The front portion 33A of the first′ beam 33 and the front portion 32A of the second beam 32 are joined to each other by being sandwiched between a first′ inner front plate P1′ that is located on the inner side of the beam 3 (32, 33) and extends over the front portion 33A of the first′ beam 33 and the front portion 32A of the second beam 32 and a first′ outer front plate P2′ that is located on the outer side of the beam 3 (32, 33) and extends over the front portion 33A of the first′ beam 33 and the front portion 32A of the second beam 32, and joined with the bolts (B1′ to B2′) and the nuts (N1′ to N2′).

The back portion 33C of the first′ beam 33 and the back portion 32C of the second beam 32 are joined to each other by being sandwiched between a first′ inner back plate P3′ that is located on the inner side of the beam 3 (32, 33) and extends over the back portion 33C of the first′ beam 33 and the back portion 32C of the second beam 32 and a first′ outer back plate P4′ that is located on the outer side of the beam 3 (32, 33) and extends over the back portion 33C of the first′ beam 33 and the back portion 32C of the second beam 32, and joined with the bolts (B3′ to B4′) and the nuts (N3′ to N4′).

The bottom portion 33D of the first′ beam 33 and the bottom portion 32D of the second beam 32 are joined to each other by being sandwiched between a first′ inner bottom plate P5′ that is located on the inner side of the beam 3 (32, 33) and extends over the bottom portion 33D of the first′ beam 33 and the bottom portion 32D of the second beam 32 and a first′ outer bottom plate P6′ that is located on the outer side of the beam 3 (32, 33) and extends over the bottom portion 33D of the first′ beam 33 and the bottom portion 32D of the second beam 32, and joined with the bolts (B5′ to B8′) and the nuts (N5′ to N8′).

Accordingly, in the above-mentioned junction structure C between structures, by providing the inclined portion X of the first beam 31 inclined at A degrees (A<90), the inclined portion Y of the second beam 32 inclined at B degrees (180 degrees−A degrees), the inclined portion X′ of the first′ beam 33 inclined at A degrees (A<90), and the inclined portion Y′ of the second beam 32 inclined at B degrees (180 degrees−A degrees). The three surfaces other than the upper surface of the first beam 31 and the three surfaces other than the upper surface of the second beam 32 are sandwiched between the plates (P1 to P6) from the inner and outer sides, and joined together with the bolts (B1 to B8) and the nuts (N1 to N8) in this state, respectively, and the upper surfaces can be joined to each other by welding. Thus, the junction structure between structures that has a high strength, uses less welding as compared to the junction structure between structures having four welded surfaces, and improves workability at a high altitude can be realized.

Next, a junction method of the beam 3 formed by connecting the rectangular first beam 31 having a rectangular cross section to the rectangular second beam 32 having a rectangular cross section will be described below with reference to FIG. 1 to FIG. 17.

When viewed from the front, a portion of the first beam 31 to be connected to the second beam 32 is the first inclined surface X formed from the bottom portion 31D of the first beam 31 toward the upper portion 31B at A degrees (A<90), and a portion of the second beam 32 to be connected to the first beam 31 is the second inclined surface Y formed from the bottom portion 32D of the second beam 32 toward the upper portion 32B at B degrees (180 degrees−A degrees).

The connection portions of the front portion 31A of the first beam 31 and the front portion 32A of the second beam 32 are sandwiched between the first inner front plate P1 on the inner side and the first outer front plate P2 on the outer side. The connection portions of the back portion 31C of the first beam 31 and the back portion 32C of the second beam 32 are sandwiched between the first inner back plate P3 on the inner side and the first outer back plate P4 on the outer side. The connection portions of the bottom portion 31D of the first beam 31 and the bottom portion 32D of the second beam 32 are sandwiched between the first inner bottom plate P5 on the inner side and the first outer bottom plate P6 on the outer side.

As shown in FIG. 14, the first outer front plate P2 has a first outer temporary tightening front hole a and a first outer front hole b, and the first outer front hole b is located outer than the first outer temporary tightening front hole a. The first inner front plate P1 opposed to the first outer front plate P2 has a first inner temporary tightening front hole c corresponding to the first outer temporary tightening front hole a and a first inner front threaded hole d that corresponds to the first outer front hole b and in which a female screw is cut, and the first inner front threaded hole d is located outer than the first inner temporary tightening front hole c.

The front portion 31A of the first beam 31 has a temporary tightening front hole o corresponding to the first outer temporary tightening front hole a and the first inner temporary tightening front hole c, and the front portion 32A of the second beam 32 has a first front hole e corresponding to the first inner front threaded hole d and the first outer front hole b.

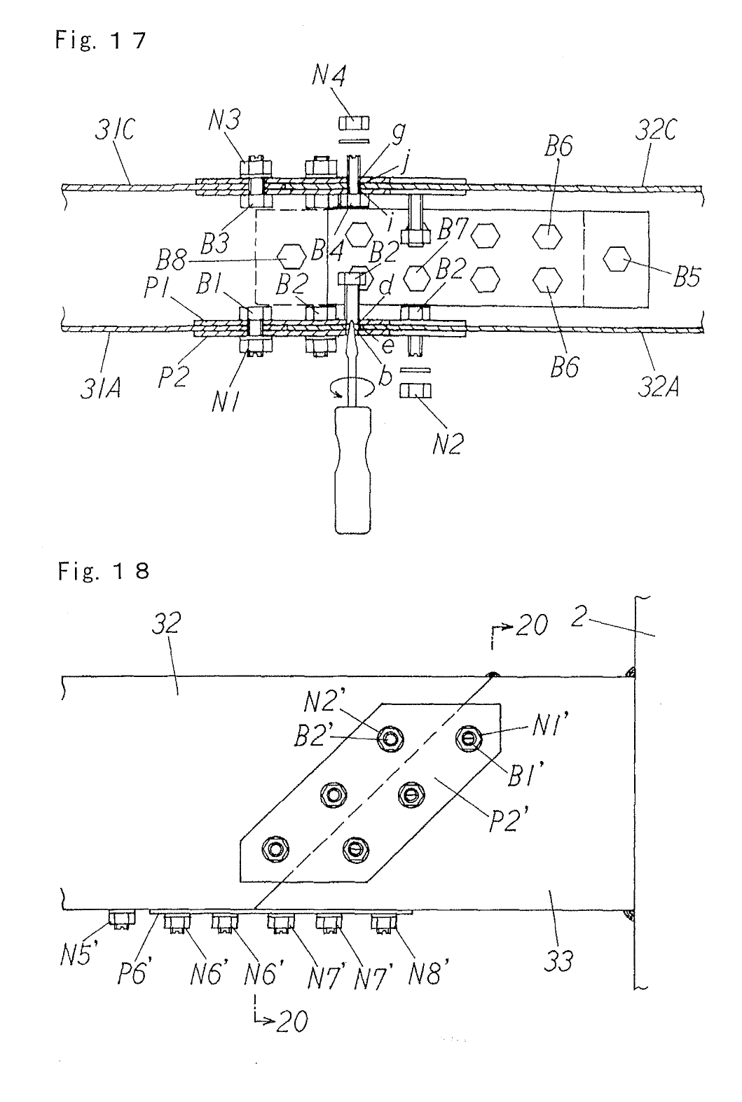

Accordingly, to couple the front portion 31A of the first beam 31 to the front portion 32A of the second beam 32, the first inner front plate P1 and the first outer front plate P2 are temporarily tightened to the inner side and the outer side of the front portion 31A of the first beam 31, respectively, through the first outer temporary tightening front hole a, the temporary tightening front hole o, and the first inner temporary tightening front hole c with the bolt B (first bolt B1) and the nut N (first nut N1) (Refer to FIG. 3, FIG. 4 and FIG. 10), the bolt B (second bolt B2) is screwed into the first inner front threaded hole d, vertically arranged and temporarily tightened such that an end opposite to its head is externally located [This state is referred to as “first front state” (Refer to FIG. 3, FIG. 4 and FIG. 10)], an end of the front portion 31A of the first beam 31 contacts with an end of the front portion 32A of the second beam 32 in the first front state, the first inner front threaded hole d, the first front hole e, and the first outer front hole b are aligned, and after alignment, the end opposite to the head of the vertically arranged bolt B (second bolt B2) is rotated to the left and pulled out by use of a driver or the like (Refer to FIG. 17) to couple the front portion 31A to the front portion 32A with the nut N (second nut N2).

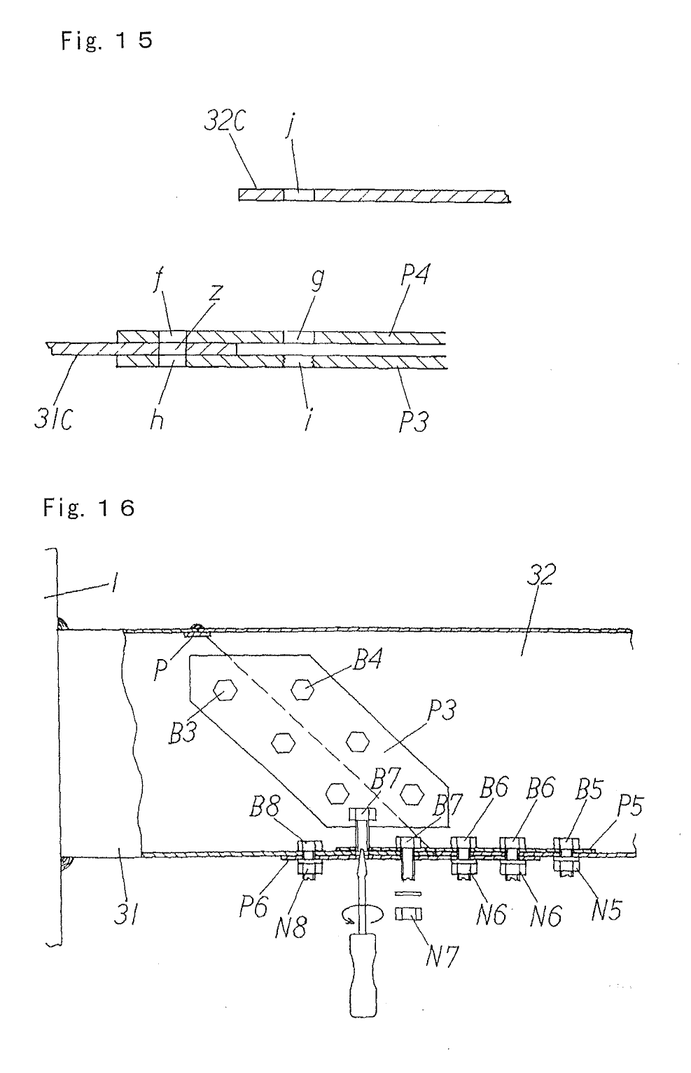

As shown in FIG. 15, the first outer back plate P4 has a first outer temporary tightening back hole f and a first outer back hole g, and the first outer back hole g is located outer than the first outer temporary tightening back hole f. The first inner back plate P3 opposed to the first outer back plate P4 includes a first inner temporary tightening back hole h corresponding to the first outer temporary tightening back hole f and a first inner back threaded hole i that corresponds to the first outer back hole g and in which is female screw is cut. The first inner back threaded hole i is located outer than the first inner temporary tightening back hole h. The back portion 31C of the first beam 31 has a temporary tightening back hole z corresponding to the first outer temporary tightening back hole f and the first inner temporary tightening back hole h.

The back portion 32C of the second beam 32 has a first back hole j corresponding to the first outer back hole g and the first inner back threaded hole i.

Accordingly, to couple the back portion 31C of the first beam 31 to the back portion 32C of the second beam 32, the first inner back plate P3 and the first outer back plate P4 are temporarily tightened to the inner and outer sides of the back portion 31C of the first beam 31 through the first outer temporary tightening back hole f, the temporary tightening back hole z, and the first inner temporary tightening back hole h with the bolt B (third bolt B3) and the nut N (third nut N3), the bolt B (fourth bolt B4) is screwed into the first inner back threaded hole i, vertically arranged and temporarily tightened such that an end opposite to its head is externally located [This state is referred to as “first back state” (Refer to FIG. 3, FIG. 4 and FIG. 10)]. An end of the back portion 31C of the first beam 31 contacts with an end of the back portion 32C of the second beam 32 in the first back state, the first inner back threaded hole i, the first back hole j, and the first outer back hole g are aligned, and after alignment, the end opposite to the head of the vertically arranged bolt B (fourth bolt B4) is rotated to the left and pulled out by use of a driver or the like (Refer to FIG. 17) to couple the back portion 31C to the back portion 32C with the nut N (fourth nut N4).

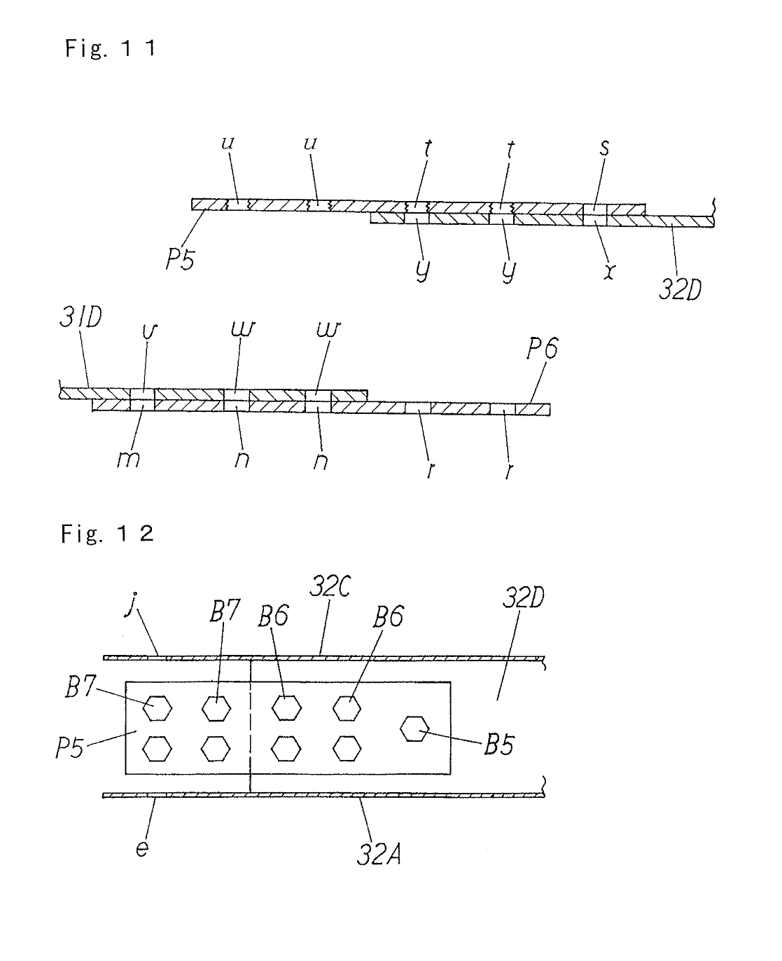

As shown in FIG. 10 and FIG. 11, the first outer bottom plate P6 sequentially has a first outer temporary tightening bottom hole m, a first outer bottom hole n, and a second outer bottom hole r toward the outer side.

The first inner bottom plate P5 sequentially has a first inner temporary tightening bottom hole s, a first inner bottom threaded hole t in which is female screw is cut, and a second inner bottom threaded hole u in which is female screw is cut toward the outer side, the first inner bottom threaded hole t corresponds to the second outer bottom hole r, and the second inner bottom threaded hole u corresponds to the first outer bottom hole n.

The bottom portion 31D of the first beam 31 sequentially has a first beam inner bottom hole v and a first beam outer bottom hole w toward the outer side, the first beam inner bottom hole v corresponds to the first outer temporary tightening bottom hole m, and the first beam outer bottom hole w corresponds to the first outer bottom hole n and the second inner bottom threaded hole u.

The bottom portion 32D of the second beam 32 sequentially has a second beam inner bottom hole x and a second beam outer bottom hole y toward the outer side, the second beam inner bottom hole x corresponds to the first inner temporary tightening bottom hole s, and the second beam outer bottom hole y corresponds to the first inner bottom threaded hole t and the second outer bottom hole r.

Accordingly, to couple the bottom portion 31D of the first beam 31 to the bottom portion 32D of the second beam 32, the first outer bottom plate P6 is temporarily tightened to the outer side of the bottom portion 31D of the first beam 31 through the first beam inner bottom hole v, and the first outer temporary tightening bottom hole m with the bolt B (eighth bolt B8) and the nut N (eighth nut N8) [This state is referred to as “first bottom state” (Refer to FIG. 3, FIG. 4 and FIG. 10)].

The first inner bottom plate P5 is temporarily tightened to the inner side of the bottom portion 32D of the second beam 32 through the first inner temporary tightening bottom hole s and the second beam inner bottom hole x with the bolt B (fifth bolt B5) and the nut N (fifth nut N5), the bolts B (sixth bolt B6, seventh bolt B7) are screwed into the first inner bottom threaded hole t and the second inner bottom threaded hole u, respectively, vertically arranged and temporarily tightened such that end opposite to their heads are externally located [This state is referred to as “second bottom state” (Refer to FIG. 3, FIG. 4 and FIG. 10)”]. An end of the bottom portion 32D of the second beam 32 in the second bottom state contacts with an end of the bottom portion 31D of the first beam 31 in the first bottom state. The first inner bottom threaded hole t, the second beam outer bottom hole y, and the second outer bottom hole r, and the second inner bottom threaded hole u, the first beam outer bottom hole w, and the first outer bottom hole n are aligned, and after alignment, the ends opposite to the heads of the vertically arranged bolts B (sixth bolt B6, seventh bolt B7) are rotated to the left and pulled out by use of a driver or the like (Refer to FIG. 16) to couple the plate with the nuts N (sixth nut N6, seventh nut N7), respectively.

After tightening (final tightening) of the bolts B (first bolt B1 to eighth bolt B8) with the nuts N (first nut N1 to eighth nut N8), by joining contact portions of the upper portion 31B of the first beam 31 and the upper portion 32B of the second beam 32 to each other by welding, the first beam 31 can be joined to the second beam 32.

Accordingly, according to the above-mentioned beam junction method, the inclined portion X of the first beam 31 inclined at A degrees (A<90) and the inclined portion Y of the second beam 32 inclined at B degrees (180 degrees−A degrees) are provided, and the inclined portion X of the first beam 31 inclined at A degrees (A<90) contacts with the inclined portion Y of the second beam 32 inclined at B degrees (180 degrees−A degrees). Three surfaces other than an upper surface are sandwiched by the first inner front plate P1, the first outer front plate P2, the first inner back plate P3, the first outer back plate P4, the first inner bottom plate P5, and the first outer bottom plate P6 from the inner and outer sides with the first bolt B1 to eighth bolt B8 and the first nut N1 to eighth nut N8, and the upper surfaces are joined to each other by welding. Thus, the junction structure between structures that has a high strength, uses less welding as compared to the junction structure between structures having four welded surfaces, and improves workability at a high altitude can be realized.

Next, a junction method of the beam 3 formed by connecting the rectangular second beam 32 having a rectangular cross section to the rectangular third beam 33 having a rectangular cross section will be described below with reference to FIG. 5, FIG. 18 to FIG. 28.

When viewed from the front, a portion of the second beam 32 to be connected to the third beam 33 is the second inclined surface Y′ formed from the bottom portion 32D of the second beam 32 toward the upper portion 32B at B degrees (180 degrees−A degrees). When viewed from the front, a portion of the third beam 33 connecting to the second beam 32 is the first inclined surface X′ formed from the bottom portion 33D of the third beam 33 toward the upper portion 33B at A degrees (A<90).

The connection portions of the front portion 32A of the second beam 32 and the front portion 33A of the third beam 33 are sandwiched between the first′ inner front plate P1′ on the inner side and the first′ outer front plate P2′ on the outer side. The connection portions of the back portion 32C of the second beam 32 and the back portion 33C of the third beam 33 are sandwiched between the first′ inner back plate P3′ on the inner side and the first′ outer back plate P4′ on the outer side. The connection portions of the bottom portion 32D of the second beam 32 and the bottom portion 33D of the third beam 33 are sandwiched between the first′ inner bottom plate P5′ on the inner side and the first′ outer bottom plate P6′ on the outer side.

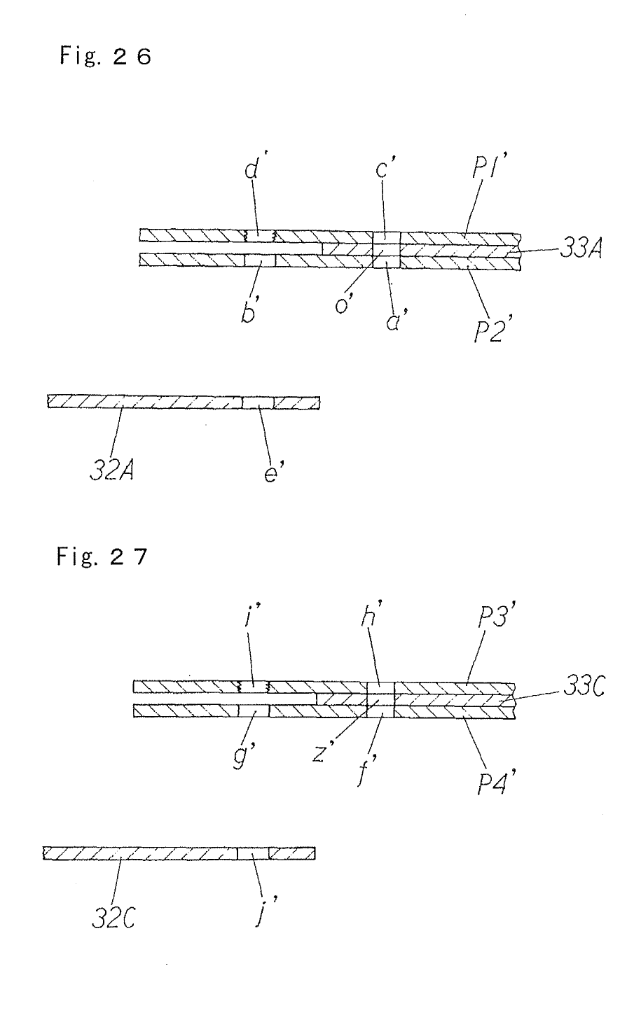

As shown in FIG. 26, the first′ outer front plate P2′ has a first′ outer temporary tightening front hole a′ and a first′ outer front hole b′, and the first′ outer front hole b′ is located outer than the first′ outer temporary tightening front hole a′. The first′ inner front plate P1′ opposed to the first′ outer front plate P2′ has a first′ inner temporary tightening front hole c′ and a first′ inner front threaded hole d′ in which is female screw is cut. The first′ inner front threaded hole d′ is located outer than the first′ inner temporary tightening front hole c′. The first′ inner temporary tightening front hole c′ corresponds to the first′ outer temporary tightening front hole a′, and the first′ inner front threaded hole d′ corresponds to the first′ outer front hole b′.

The front portion 32A of the second beam 32 has a first′ front hole e′ corresponding to the first′ outer front hole b′ and the first′ inner front threaded hole d′. The front portion 33A of the third beam 33 has a temporary tightening front hole o′, and the temporary tightening front hole o′ corresponds to the first′ inner temporary tightening front hole c′ and the first′ outer temporary tightening front hole a′.

Accordingly, to couple the front portion 32A of the second beam 32 to the front portion 33A of the third beam 33, the first′ inner front plate P1′ and the first′ outer front plate P2′ are temporarily tightened to the inner and outer sides of the front portion 33A of the third beam 33 through the first′ outer temporary tightening front hole a′, the temporary tightening front hole o′, and the first′ inner temporary tightening front hole c′ with the bolt B (first′ bolt B1′) and the nut N (first′ nut N1′). The bolt B (second′ bolt B2′) is screwed into the first′ inner front threaded hole d′, vertically arranged and temporarily tightened such that an end opposite to its head is externally located [This state is referred to as “first′ front state” (Refer to FIG. 5, FIG. 21 and FIG. 23)]. An end of the front portion 33A of the third beam 33 in the first′ front state contacts with the front portion 32A of the second beam 32. The first′ inner front threaded hole d′, the first′ front hole e′, and the first′ outer front hole b′ are aligned, and after alignment, the end opposite to the head of the vertically arranged bolt B (second′ bolt B2′) is rotated to, the left and pulled out by use of a driver or the like (Refer to FIG. 25) to couple the front portion 32A to the front portion 33A with the nut N (second′ nut N2′).

As shown in FIG. 27, the first′ outer back plate P4′ has a first′ outer temporary tightening back hole f′ and a first′ outer back hole g′, and the first′ outer back hole g′ is located outer than the first′ outer temporary tightening back hole f′. The first′ inner back plate P3′ opposed to the first′ outer back plate P4′ has a first′ inner temporary tightening back hole h′ and a first′ inner back threaded hole i′ in which is female screw is cut. First′ inner back threaded hole i′ is located outer than the first′ inner temporary tightening back hole h′, the first′ inner temporary tightening back hole h′ corresponds to the first′ outer temporary tightening back hole f′, and the first′ inner back threaded hole i′ corresponds to the first′ outer back hole g′.

The back portion 33C of the third beam 33 has a temporary tightening back hole z′, and the temporary tightening back hole z′ corresponds to the first′ outer temporary tightening back hole f′ and the first′ inner temporary tightening back hole h′.

The back portion 32C of the second beam 32 has a first′ back hole j′, and the first′ back hole j′ corresponds to the first′ inner back threaded hole i′ and the first′ outer back hole g′.

Accordingly, to couple the back portion 32C of the second beam 32 to the back portion 33C of the third beam 33, the first′ inner back plate P3′ and the first′ outer back plate P4′ are temporarily tightened to the inner and outer sides of the back portion 33C of the third beam 33 through the first′ outer temporary tightening back hole f′, the temporary tightening back hole z′, and the first′ inner temporary tightening back hole h′ with the bolt B (third′ bolt B3′) and the nut N (third′ nut N3′). The bolt B (fourth′ bolt B4′) is screwed into the first′ inner back threaded hole i′, vertically arranged and temporarily tightened such that an end opposite to its head is externally located [This state is referred to as “first′ back state” (Refer to FIG. 5, FIG. 21 and FIG. 23)]. An end of the back portion 33C of the third beam 33 in the first′ back state contacts with the back portion 32C of the second beam 32, the first′ inner back threaded hole i′, the first′ back hole j′, and the first′ outer back hole g′ are aligned, and after alignment, the end opposite to the head of the vertically arranged bolt B (fourth′ bolt B4′) is rotated to the left and pulled out by use of a driver of the like (Refer to FIG. 25) to couple the back portion 32C to the back portion 33 with the nut N (fourth′ nut N4′).

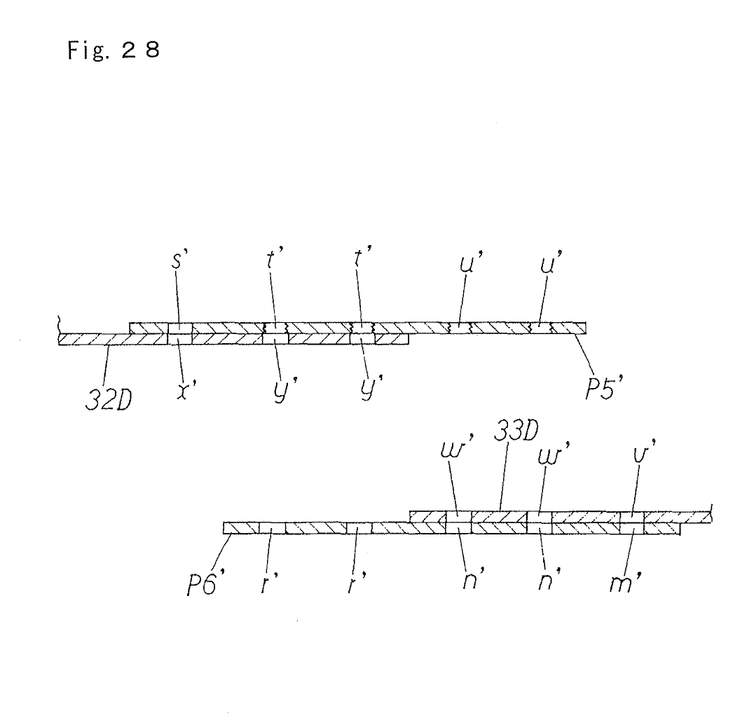

As shown in FIG. 5, FIG. 21 and FIG. 28, the first′ outer bottom plate P6′ sequentially has a first′ outer temporary tightening bottom hole m′, a first outer bottom hole n′, and a second outer bottom hole r′ toward the outer side.

The first′ inner bottom plate P5′ sequentially has a first′ inner temporary tightening bottom hole s′, a first′ inner bottom threaded hole t′ in which is female screw is cut. A second′ inner bottom threaded hole u′ in which is female screw is cut toward the outer side, the first′ inner bottom threaded hole t′ corresponds to the second outer bottom hole r′, and the second′ inner bottom threaded hole u′ corresponds to the first outer bottom hole n′.

The bottom portion 33D of the third beam 33 sequentially has a first′ beam inner bottom hole v′ and a first′ beam outer bottom hole w′ toward the outer side, the first′ beam inner bottom hole v′ corresponds to the first′ outer temporary tightening bottom hole m′, and the first′ beam outer bottom hole w′ corresponds to the first outer bottom hole n′.

The bottom portion 32D of the second beam 32 sequentially has a second′ beam inner bottom hole x′ and a second′ beam outer bottom hole y′ toward the outer side, the second′ beam inner bottom hole x′ corresponds to the first inner temporary tightening bottom hole s′, and the second′ beam outer bottom hole y′ corresponds to the first′ inner bottom threaded hole t′.

Accordingly, to couple the bottom portion 32D of the second beam 32 to the bottom portion 33D of the third beam 33, the first′ outer bottom plate P6′ is temporarily tightened to the outer side of the bottom portion 33D of the first′ beam 33 through the first′ beam inner bottom hole v′ and the first′ outer temporary tightening bottom hole m′ with the bolt B (eighth′ bolt B8′) and the nut N (eighth′ nut N8′) [This state is referred to as “first′ bottom state” (Refer to FIG. 5, FIG. 21 and FIG. 23)].

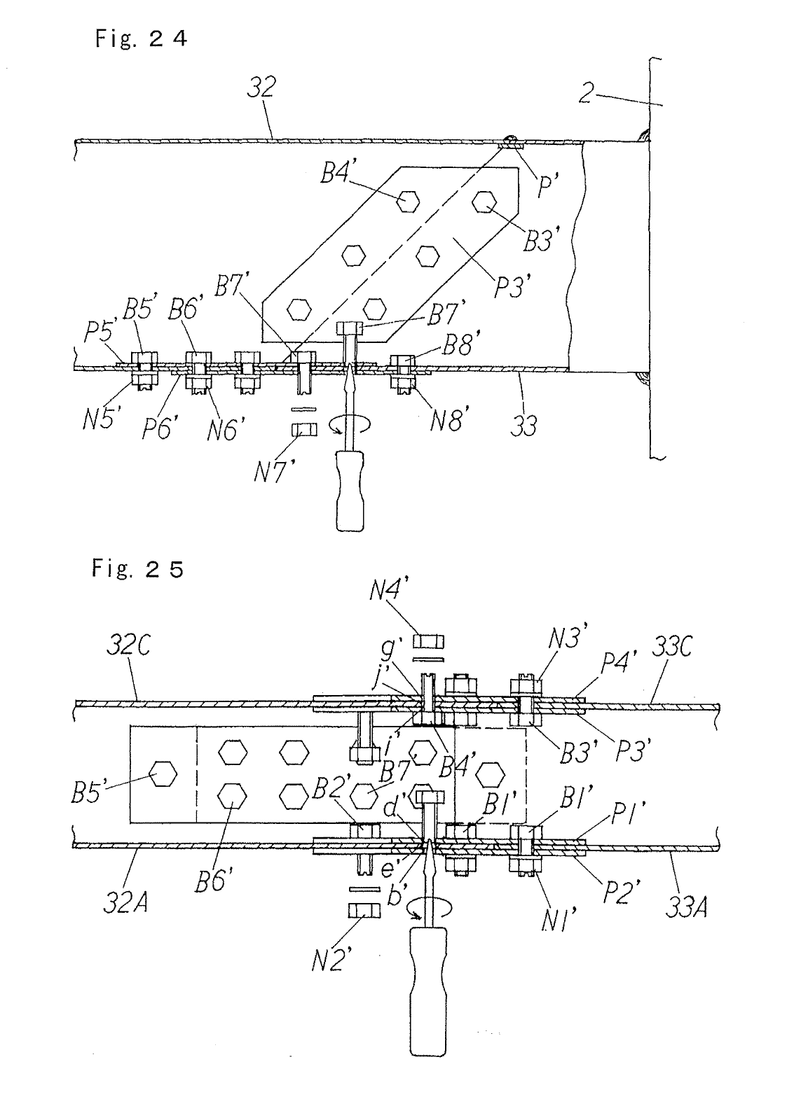

The first′ inner bottom plate P5′ is temporarily tightened to the inner side of the bottom portion 32D of the second beam 32 through the first′ inner temporary tightening bottom hole s′ and the second′ beam inner bottom hole x′ with the bolt B (fifth′ bolt B5′) and the nut N (fifth′ nut N5′). The bolts B (sixth′ bolt B6′, seventh′ bolt B7′) are screwed into the first′ inner bottom threaded hole t′ and the second′ inner bottom threaded hole u′, respectively, vertically arranged and temporarily tightened such that ends opposite to their heads are externally located [This state is referred to as “second′ bottom state” (Refer to FIG. 5, FIG. 21 and FIG. 23)”. An end of the bottom portion 32D of the second beam 32 in the second′ bottom state contacts with an end of the bottom portion 33D of the first′ beam 33 in the first′ bottom state, the first′ inner bottom threaded hole t′, the second′ beam outer bottom hole y′, and the second outer bottom hole r′, and the second′ inner bottom threaded hole u′, the first′ beam outer bottom hole w′, and the first outer bottom hole n′ are aligned, and after alignment, the ends opposite to the heads of the vertically arranged bolt B (sixth′ bolt B6′, seventh′ bolt B7′) are rotated to the left and pulled out by use of a driver or the like (Refer to FIG. 24) to couple the bottom portion 32D to the bottom portion 32D with the nut N (sixth′ nut N6′, seventh′ nut N7′), respectively.

After tightening (final tightening) of the above-mentioned bolts B (first′ bolt B1′ to eighth′ bolt B8′) with the nut N [first′ nut N1′ to eighth′ nut N8′), the contact portions of the upper portion 32B of the second beam 32 and the upper portion 33B of the third beam 33 are joined together by welding, thereby joining the second beam 32 to the third beam 33. P′ is a plate provided on the inner side so as to extend over the upper portion 32B of the second beam 32 and the upper portion 33B of the third beam 33 (FIG. 5, FIG. 20 and FIG. 21).

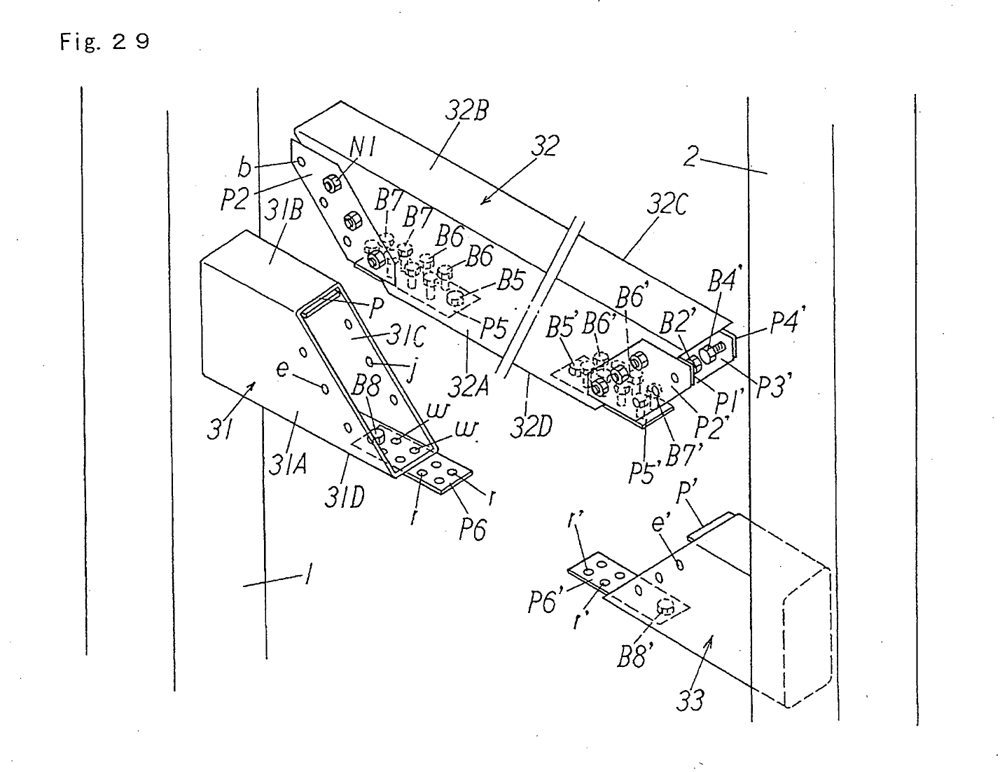

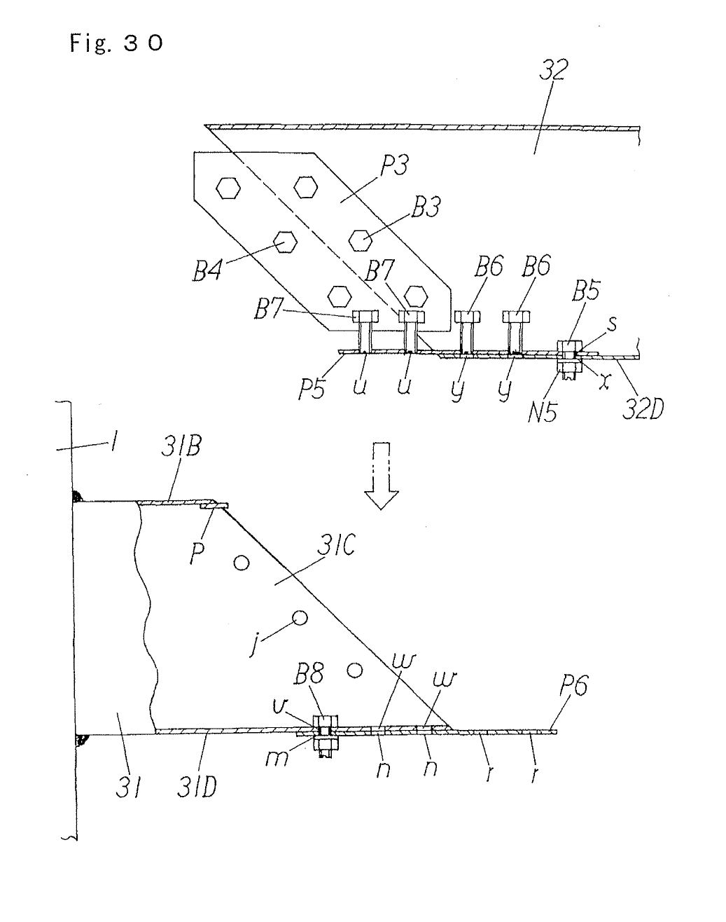

In the above-mentioned embodiment, the first inner front plate P1 and the first outer front plate P2 are attached to the front portion 31A of the first beam 31, and the first inner back plate P3 and the first outer back plate P4 are attached to the back portion 31C of the first beam 31 to couple the first beam 31 to the second beam 32. However, the present invention is not limited to this, and the first inner front plate P1 and the first outer front plate P2 may be attached to the front portion 32A of the second beam 32, and the first inner back plate P3 and the first outer back plate P4 may be attached to the back portion 32C of the second beam 32 (Refer to FIG. 29 to FIG. 37).

Since the first inner front plate P1 and the first outer front plate P2 are attached to the second beam 32, not to the first beam 31, the first front hole e provided in the front portion 32A of the second beam 32 is replaced with the temporary tightening front hole in this embodiment, and the temporary tightening front hole o provided in the front portion 31A of the first beam 31 is replaced with the first front hole e in this embodiment.

Since the first inner back plate P3 and the first outer back plate P3 are attached to the second beam 32, not to the first beam 31, the first back hole j provided in the back portion 32C of the second beam 32 is replaced with the temporary tightening back hole z in this embodiment, and the temporary tightening back hole z provided in the back portion 31C of the first beam 31 is replaced with the first back hole j in this embodiment.

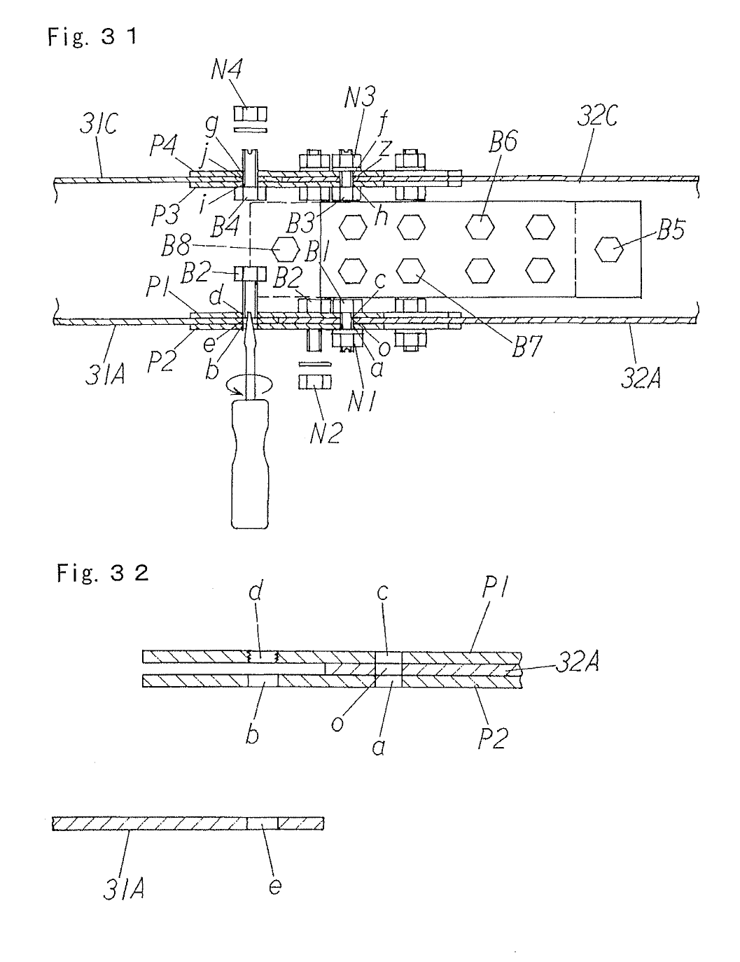

That is, as shown in FIG. 31 and FIG. 32, the front portion 31A of the first beam 31 has the first front hole e, and the first front hole e corresponds to the first inner front threaded hole d provided in the first inner front plate P1 and the first outer front hole b provided in the first outer front plate P2. The temporary tightening front hole o provided in the front portion 32A of the second beam 32 corresponds to the first inner temporary tightening front hole c provided in the first inner front plate P1 and the first outer temporary tightening front hole a provided in the first outer front plate P2. In the first inner front plate P1, the first inner front threaded hole d located outer than the first inner temporary tightening front hole c, and in the first outer front plate P2, the first outer front hole b is located outer than the first outer temporary tightening front hole a.

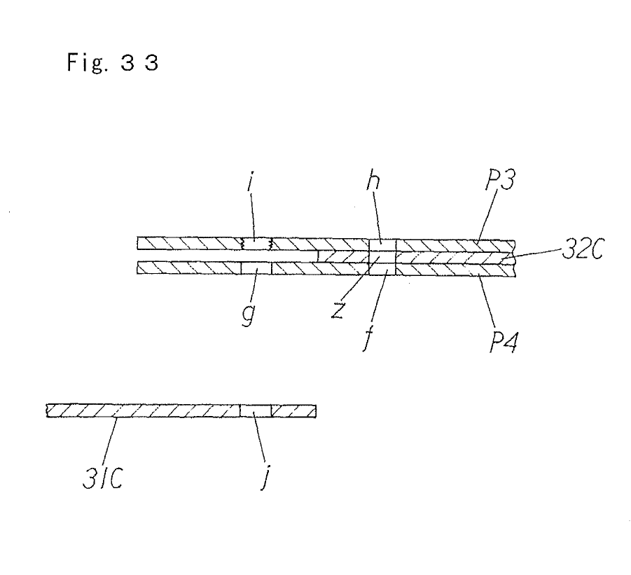

As shown in FIG. 31 and FIG. 33, the back portion 31C of the first beam 31 has the first back hole j, and the first back hole j corresponds to the first inner back threaded hole i provided in the first inner back plate P3 and the first outer back hole g provided in the first outer back plate P4. The temporary tightening back hole z provided in the back portion 32C of the second beam 32 corresponds to the first inner temporary tightening back hole h provided in the first inner back plate P3 and the first outer temporary tightening back hole f provided in the first outer back plate P4. In the first inner back plate P3, the first inner back threaded hole i is located outer than the first inner temporary tightening back hole h, and in the first outer back plate P4, first outer back hole g is located outer than the first outer temporary tightening back hole f.

As shown in FIG. 29 to FIG. 33, to couple the front portion 31A of the first beam 31 to the front portion 32A of the second beam 32, the first inner front plate P1 and the first outer front plate P2 are temporarily tightened to the inner and outer sides of the front portion 31A of the first beam 31 through the first outer temporary tightening front hole a, the temporary tightening front hole o, the first inner temporary tightening front hole c with the bolt B (first bolt B1) and the nut N (first nut N1). The bolt B (second bolt B2) is screwed into the first inner front threaded hole d, vertically arranged and temporarily tightened such that an end opposite to its head is externally located [This state is referred to as “first′ front state” (Refer to FIG. 29)]. An end of the front portion 31A of the first beam 31 in the first′ front state contacts with an end of the front portion 32A of the second beam 32. The first inner front threaded hole d, the first front hole e, and the first outer front hole b are aligned, and after alignment, the end opposite to the head of the vertically arranged bolt B (second bolt B2) is rotated to the left and pulled out by use of a driver or the like (Refer to FIG. 31) to couple the front portion 31A to the front portion 32A with the nut N (second nut N2).

To couple the back portion 31C of the first beam 31 to the back portion 32C of the second beam 32, the first inner back plate P3 and the first outer back plate P4 are temporarily tightened to the inner and outer sides of the back portion 32C of the second beam 32 through the first inner back threaded hole i, the first outer temporary tightening back hole f, the temporary tightening back hole z, and the first inner temporary tightening back hole h with the bolt B (third bolt B3) and the nut N (third nut N3). The bolt B (fourth bolt B4) is screwed into the first inner front threaded hole d, vertically arranged and temporarily tightened such that an end opposite to its head is externally located [This state is referred to as “first′ back state” (Refer to FIG. 29 and FIG. 31)]. An end of the back portion 31C of the first beam 31 in the first′ back state contacts with an end of the back portion 32C of the second beam 32, the first inner back threaded hole i, the first back hole j, and the first outer back hole g are aligned, and after alignment, the end opposite to the head of the vertically arranged bolt B (fourth bolt B4) is rotated to the left and pulled out by use of a driver or the like (Refer to FIG. 31) to couple the back portion 31C to the back portion 32C with the nut N (fourth nut N4).

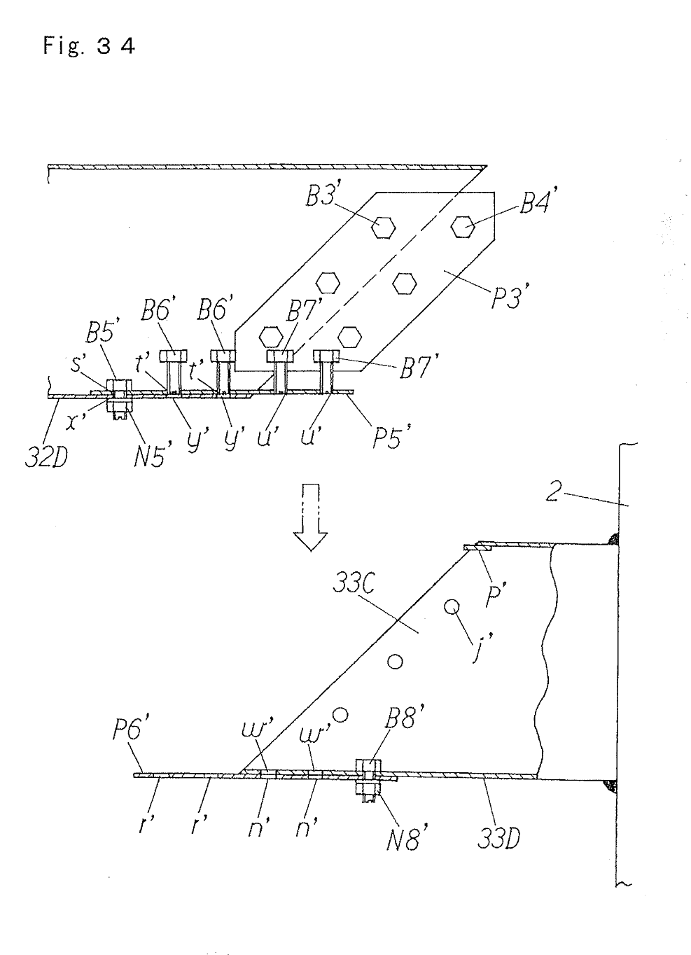

Since coupling of the bottom portion 31D of the first beam 31 to the bottom portion 32D of the second beam 32 in this embodiment (FIG. 29 to FIG. 33) is similar to that in the former embodiment (FIG. 1 to FIG. 28), the same parts in this embodiment (FIG. 29 to FIG. 33, especially, FIG. 34) as those in the former embodiment (FIG. 1 to FIG. 28, especially, FIG. 10, FIG. 11) are given the same reference numerals and description thereof is omitted.

In the above-mentioned embodiment, the first′ inner front plate P1′ and the first′ outer front plate P2′ are attached to the front portion 33A of the first′ beam 33, and the first′ inner back plate P3′ and the first′ outer back plate P4′ are attached to the back portion 33C of the first′ beam 33, thereby joining the first′ beam 33 to the second beam 32. However, the present invention is not limited to this, and the first′ inner front plate P1′ and the first′ outer front plate P2′ may be attached to the front portion 32A of the second beam 32, and the first′ inner back plate P3′ and the first′ outer back plate P4′ may be attached to the back portion 32C of the second beam 32 (Refer to FIG. 29, FIG. 34 to FIG. 37).

Since the first′ inner front plate P1′ and the first′ outer front plate P2′ are attached to the second beam 32, not to the first′ beam 33, the first′ front hole e′ provided in the front portion 32A of the second beam 32 is replaced with the temporary tightening front hole o′ in this embodiment, and the temporary tightening front hole o′ provided in the front portion 33A of the first′ beam 33 is replaced with the first′ front hole e′ in this embodiment.

Since the first′ inner back plate P3′ and the first′ outer back plate P4′ are attached to the second beam 32, not to the first′ beam 33, the first′ back hole j′ provided in the back portion 32C of the second beam 32 is replaced with the temporary tightening back hole z′ in this embodiment, and the temporary tightening back hole z′ provided in the back portion 33C of the first′ beam 33 is replaced with the first′ back hole j′ in this embodiment.

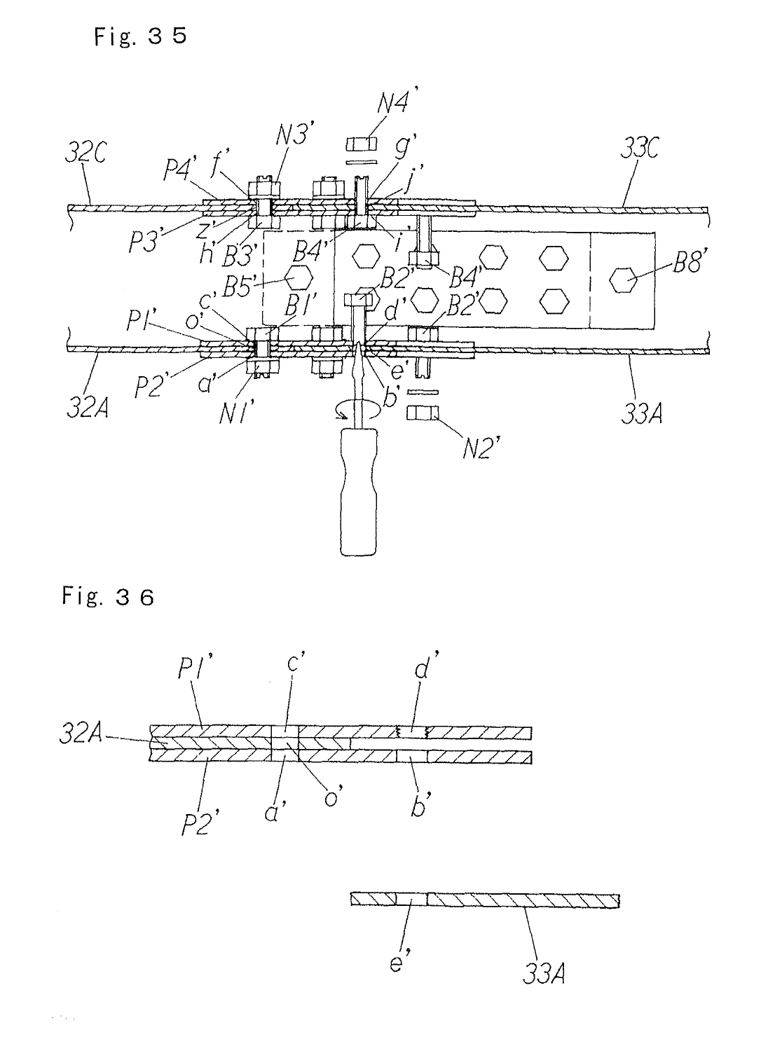

That is, as shown in FIG. 35 and FIG. 36, the front portion 33A of the first′ beam 33 has the first′ front hole e′, and the first′ front hole e′ corresponds to the first′ inner front threaded hole d′ provided in the first′ inner front plate P1′ and the first′ outer front hole b′ provided in the first′ outer front plate P2′. The temporary tightening front hole o′ provided in the front portion 32A of the second beam 32 corresponds to the first′ inner temporary tightening front hole c′ provided in the first′ inner front plate P1′ and the first′ outer temporary tightening front hole a′ provided in the first′ outer front plate P2′. In the first′ inner front plate P1′, the first′ inner front threaded hole d′ is located outer than the first′ inner temporary tightening front hole c′, and in the first′ outer front plate P2′, first′ outer front hole b′ is located outer than the first′ outer temporary tightening front hole a′.

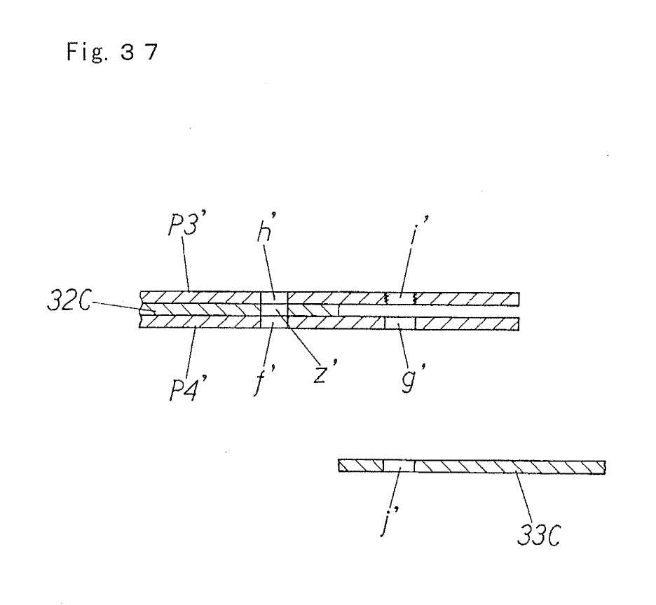

As shown in FIG. 35 and FIG. 37, the back portion 33C of the first′ beam 33 has the first′ back hole j′, and the first′ back hole j′ corresponds to the first′ inner back threaded hole i′ provided in the first′ inner back plate P3′ and the first′ outer back hole g′ provided in the first′ outer back plate P4′. The temporary tightening back hole z′ provided in the back portion 32C of the second′ beam 32 corresponds to the first′ inner temporary tightening back hole h′ provided in the first′ inner back plate P3′ and the first′ outer temporary tightening back hole f′ provided in the first′ outer back plate P4′. In the first′ inner back plate P3′, the first′ inner back threaded hole i′ is located outer than the first′ inner temporary tightening back hole h′, in the first′ outer back plate P4′, first′ outer back hole g′ is located outer than the first′ outer temporary tightening back hole f′.

As shown in FIG. 29, FIG. 34 to FIG. 37, to couple the front portion 33A of the first′ beam 33 to the front portion 32A of the second beam 32, the first′ inner front plate P1′ and the first′ outer front plate P2′ are temporarily tightened to the inner and outer sides of the front portion 33A of the first′ beam 33 through the first′ outer temporary tightening front hole a′, the temporary tightening front hole o′, and the first′ inner temporary tightening front hole c′ with the bolt B (first′ bolt B1′) and the nut N (first′ nut N1′). The bolt B (second bolt B2′) is screwed into the first inner front threaded hole d, vertically arranged and temporarily tightened such that an end opposite to its head is externally located [This state is referred to as “first′ front state” (Refer to FIG. 29)]. The end of the front portion 33A of the first′ beam 33 in the first′ front state contacts with an end of the front portion 32A of the second beam 32. The first′ inner front threaded hole d′, the first′ front hole e′, and the first′ outer front hole b′ are aligned, and after alignment, the end opposite to the head of the vertically arranged bolt B (second bolt B2′) is rotated to the left and pulled out by use of a driver or the like (Refer to FIG. 35) to couple the front portion 33A to the front portion 32A with the nut N (second nut N2′).

To couple the back portion 33C of the first′ beam 33 to the back portion 32C of the second beam 32, the first′ inner back plate P3′ and first′ outer back plate P4′ are temporarily tightened to the inner and outer sides of the back portion 32C of the second beam 32 through the first′ outer temporary tightening back hole f′, the temporary tightening back hole z′, the first′ inner temporary tightening back hole h′ and the first′ inner back threaded hole i′ with the bolt B (third bolt B3′) and the nut N (third nut N3′). The bolt B (fourth bolt B4′) is screwed into the first inner front threaded hole d, vertically arranged and temporarily tightened such that an end opposite to its head is externally located [This state is referred to as “first′ back state” (Refer to FIG. 29 and FIG. 34)]. An end of the back portion 33C of the first′ beam 33 in the first′ back state contacts with the back portion 32C of the second beam 32, the first′ inner back threaded hole i′, the first′ back hole j′, and the first′ outer back hole g′ are aligned, and after alignment, the end opposite to the head of the vertically arranged bolt B (fourth bolt B4′) is rotated to the left and pulled out by use of a driver or the like (Refer to FIG. 35) to the back portion 33 to the back portion 32 with the nut N (fourth nut N4′).

Since coupling of the bottom portion 33D of the first′ beam 33 to the bottom portion 32D of the second beam 32 in this embodiment (FIG. 29, FIG. 34 to FIG. 37) is similar to that in the former embodiment (FIG. 1 to FIG. 28), the same parts in this embodiment (FIG. 29, FIG. 34 to FIG. 37, especially, FIG. 34) as those in the former embodiment (FIG. 1 to FIG. 28, especially, FIG. 21, FIG. 28) are given the same reference numerals and description thereof is omitted.

What is claimed is:

1. A junction structure between structures to connect a hollow rectangular beam having a rectangular cross section between a first column and a first′ column,
wherein the beam includes a first beam, a second beam, and a first′ beam from the first column toward the first′ column,
the first beam has a substantially trapezoidal shape having a lower base that is longer than an upper base when viewed from front, an angle between an inclined portion of the first beam on a first column side and the lower base is 90 degrees, and an angle between an inclined portion of the first beam on a first′ column side and the lower base is A degrees (A<90),
the second beam has a substantially trapezoidal shape having an upper base that is longer than a lower base when viewed from the front, an angle between an inclined portion of the second beam on a first column side and the lower base is B degrees (180 degrees−A degrees), and an angle between an inclined portion of the second beam on a first′ column side and the lower base is B degrees (180 degrees−A degrees),
the first′ beam has a substantially trapezoidal shape having a lower base that is longer than an upper base when viewed from the front, and an angle between an inclined portion of the first′ beam on a first′ column side and the lower base is 90 degrees, and an angle between an inclined portion of the first′ beam on a first column side and the lower base is A degrees,
the first column is connected to the first beam, and the first′ column is connected to the first′ beam,
three surfaces other than an upper surface of the first beam are joined to respective three surfaces other than an upper surface of the second beam by being sandwiched by plates from inner and outer sides with bolts and nuts, and the upper surfaces are joined to each other by welding contact portions of an upper portion of the first beam and an upper portion of the second beam, and
three surfaces other than an upper surface of the first′ beam are joined to respective three surfaces other than an upper surface of the second beam by being sandwiched by plates from inner and outer sides and joined together with bolts and nuts, and the upper surfaces are joined to each other by welding contact portions of an upper portion of the first′ beam and the upper portion of the second beam.

2. A junction structure between structures according to claim 1, wherein the first beam includes a front portion of the first beam, the upper portion of the first beam, a back portion of the first beam, and a bottom portion of the first beam when viewed from the front,
on an end surface of the first beam on an opposite side of the first column, the bottom portion of the first beam protrudes from the upper portion of the first beam toward the first′ column when viewed from above,
a first inclined surface is formed from the bottom portion of the first beam toward the upper portion of the first beam at A degrees (A<90),
the first′ beam includes a front portion of the first′ beam, the upper portion of the first′ beam, a back portion of the first′ beam, and a bottom portion of the first′ beam when viewed from the front,
on an end surface of the first′ beam on an opposite side of the first′ column, the bottom portion of the first′ beam protrudes from the upper portion of the first′ beam toward the first column when viewed from the above, and
a first′ inclined surface is formed from the bottom portion of the first′ beam toward the upper portion of the first′ beam at A degrees (A<90),
the second beam includes a front portion of the second beam, the upper portion of the second beam, a back portion of the second beam, and a bottom portion of the second beam when viewed from the front,
on an end surface of the second beam toward the first column, the upper portion of the second beam protrudes from the bottom portion of the second beam toward the first column when viewed from the above,
a second inclined surface is formed from the bottom portion of the second beam toward the upper portion of the second beam at B degrees (180 degrees−A degrees),
on an end surface of the second beam toward the first′ column, the upper portion of the second beam protrudes from the bottom portion of the second beam toward the first′ column when viewed from the above,
a second′ inclined surface is formed from the bottom portion of the second beam toward the upper portion of the second beam at B degrees (180 degrees−A degrees),
an end surface of the front portion of the first beam toward the second beam contacts with an end surface of the front portion of the second beam toward the first column,
an end surface of the upper portion of the first beam toward the second beam contacts with an end surface of the upper portion of the second beam toward the first column,
an end surface of the back portion of the first beam toward the second beam contacts with an end surface of the back portion of the second beam toward the first column,
an end surface of the bottom portion of the first beam toward the second beam contacts with an end surface of the bottom portion of the second beam toward the first column,
an end surface of the front portion of the first′ beam toward the second beam contacts with the end surface of the front portion of the second beam toward the first′ column,
an end surface of the upper portion of the first′ beam toward the second beam contacts with the end surface of the upper portion of the second beam toward the first′ column,
an end surface of the back portion of the first′ beam toward the second beam contacts with the end surface of the back portion of the second beam toward the first′ column,
an end surface of the bottom portion of the first′ column toward the second beam contacts with the end surface of the bottom portion of the second beam toward the first′ column,
the front portion of the first beam and the front portion of the second beam are sandwiched between a first inner front plate, which is disposed on the inner side of the beams and extends over the front portion of the first beam and the front portion of the second beam, and a first outer front plate, which is disposed on the outer side of the beams and extends over the front portion of the first beam and the front portion of the second beam, and joined together with bolts and nuts,
the back portion of the first beam and the back portion of the second beam are sandwiched between a first inner back plate, which is disposed on the inner side of the beam and extends over the back portion of the first beam and the back portion of the second beam, and a first outer back plate, which is disposed on the outer side of the beams and extends over the back portion of the first beam and the back portion of the second beam, and joined together with the bolts and the nuts,
the bottom portion of the first beam and the bottom portion of the second beam are sandwiched between a first inner bottom plate, which is disposed on the inner side of the beams and extends over the bottom portion of the first beam and the bottom portion of the second beam, and a first outer bottom plate, which is disposed on the outer side of the beams and extends over the bottom portion of the first beam and the bottom portion of the second beam, and joined together with the bolts and the nuts,
joined portions of the upper portion of the first beam and the upper portion of the second beam are joined to each other by welding,
the front portion of the first′ beam and the front portion of the second beam are sandwiched between a first′ inner front plate, which is disposed on the inner side of the beams and extends over the front portion of the first′ beam and the front portion of the second beam, and a first′ outer front plate, which is disposed on the outer side of the beams and extends over the front portion of the first′ beam and the front portion of the second beam, and joined together with the bolts and the nuts,
the back portion of the first′ beam and the back portion of the second beam are sandwiched between a first′ inner back plate, which is disposed on the inner side of the beams and extends over the back portion of the first′ beam and the back portion of the second beam, and a first′ outer back plate, which is disposed on the outer side of the beams and extends over the back portion of the first′ beam and the back portion of the second beam, and joined together with the bolts and the nuts, and
the bottom portion of the first′ beam and the bottom portion of the second beam are sandwiched between a first′ inner bottom plate, which is disposed on the inner side of the beams and extends over the bottom portion of the first′ beam and the bottom portion of the second beam, and a first′ outer bottom plate, which is disposed on the outer side of the beams and extends over the bottom portion of the first′ beam and the bottom portion of the second beam, and joined together with the bolts and the nuts.

3. A junction structure between structures to connect a hollow rectangular beam having a rectangular cross section between a first column and a first′ column,
wherein the beam from the first column toward the first′ column includes at least a first beam and a second beam,
the first beam has a substantially trapezoidal shape having a lower base that is longer than an upper base when viewed from front, an angle between an inclined portion of the first beam on a first column side and the lower base is 90 degrees, and an angle between an inclined portion of the first beam on a first′ column side and the lower base is A degrees (A<90),
the second beam has a substantially trapezoidal shape having an upper base that is longer than a lower base when viewed from the front, an angle between an inclined portion of the second beam on a first column side and the lower base is B degrees (180 degrees−A degrees), and an angle between an inclined portion of the second beam on a first′ column side and the lower base is B degrees (180 degrees−A degrees),
the first column is connected to the first beam, and
three surfaces other than an upper surface of the first beam are joined to respective three surfaces other than an upper surface of the second beam by being sandwiched by plates from inner and outer sides and joined with bolts and nuts, and the upper surfaces are joined to each other by welding contact portions of an upper portion of the first beam and an upper portion of the second beam.

4. A junction structure between structures according to claim 3, wherein the first beam includes a front portion of the first beam, the upper portion of the first beam, a back portion of the first beam, and a bottom portion of the first beam when viewed from the front,
on an end surface of the first beam on the opposite side of the first column, the bottom portion of the first beam protrudes from the upper portion of the first beam toward the first′ column when viewed from above,
a first inclined surface is formed from the bottom portion of the first beam toward the upper portion of the first beam at A degrees (A<90),
the second beam includes a front portion of the second beam, an upper portion of the second beam, a back portion of the second beam, and a bottom portion of the second beam when viewed from the front,
on an end surface of the second beam toward the first column, the upper portion of the second beam protrudes from the bottom portion of the second beam toward the first column when viewed from the above,
a second inclined surface is formed from the bottom portion of the second beam toward the upper portion of the second beam at B degrees (180 degrees−A degrees),
an end surface of the front portion of the first beam toward the second beam contacts with an end surface of the front portion of the second beam toward the first column,
an end surface of the upper portion of the first beam toward the second beam contacts with an end surface of the upper portion of the second beam toward the first column,
an end surface of the back portion of the first beam toward the second beam contacts with an end surface of the back portion of the second beam toward the first column,
an end surface of the bottom portion of the first beam toward the second beam contacts with an end surface of the bottom portion of the second beam toward the first column,
the front portion of the first beam and the front portion of the second beam are sandwiched between a first inner front plate, which is disposed on the inner side of the beams and extends over the front portion of the first beam and the front portion of the second beam, and a first outer front plate, which is disposed on the outer side of the beams and extends over the front portion of the first beam and the front portion of the second beam, and joined together with the bolts and the nuts,
the back portion of the first beam and the back portion of the second beam are sandwiched between a first inner back plate, which is disposed on the inner side of the beams and extends over the back portion of the first beam and the back portion of the second beam, and a first outer back plate, which is disposed on the outer side of the beams and extends over the back portion of the first beam and the back portion of the second beam, and joined together with the bolts and the nuts,
the bottom portion of the first beam and the bottom portion of the second beam are sandwiched between a first inner bottom plate, which is disposed on the inner side of the beams and extends over the bottom portion of the first beam and the bottom portion of the second beam, and a first outer bottom plate, which is disposed on the outer side of the beams and extends over the bottom portion of the first beam and the bottom portion of the second beam, and joined together with the bolts and the nuts,
joined portions of the upper portion of the first beam and the upper portion of the second beam are joined to each other by welding.

5. A beam junction method for connecting a hollow rectangular first beam having a rectangular cross section to a hollow rectangular second beam having a rectangular cross section,
wherein a portion of the first beam connecting to the second beam is a first inclined surface formed from a bottom portion of the first beam toward an upper portion of the first beam at A degrees (A<90) when viewed from front,
a portion of the second beam connecting to the first beam is a second inclined surface formed from the bottom portion of the second beam toward the upper portion of the second beam at B degrees (180 degrees−A degrees) when viewed from the front,
connection portions of a front portion of the first beam and a front portion of the second beam are sandwiched between a first inner front plate on an inner side and a first outer front plate on an outer side,
connection portions of a back portion of the first beam and a back portion of the second beam are sandwiched between a first inner back plate on the inner side and a first outer back plate on the outer side,
connection portions of the bottom portion of the first beam and the bottom portion of the second beam are sandwiched between a first inner bottom plate on the inner side and a first outer bottom plate on the outer side,
the first outer front plate includes a first outer temporary tightening front hole and a first outer front hole,
the first inner front plate includes a first inner temporary tightening front hole corresponding to the first outer temporary tightening front hole and a first inner front threaded hole corresponding to the first outer front hole in which a female screw is cut,
the front portion of the first beam includes a temporary tightening front hole, and the front portion of the second beam includes a first front hole corresponding to the first outer front hole and the first inner front threaded hole,
the first outer back plate includes a first outer temporary tightening back hole and a first outer back hole,
the first inner back plate includes a first inner temporary tightening back hole corresponding to the first outer temporary tightening back hole and a first inner back threaded hole corresponding to the first outer back hole in which a female screw is cut,
the back portion of the first beam includes a temporary tightening back hole, and the back portion of the second beam includes a first back hole corresponding to the first outer back hole and the first inner back threaded hole,
the first outer bottom plate includes a first outer temporary tightening bottom hole, a first outer bottom hole, and a second outer bottom hole,
the first inner bottom plate includes a first inner temporary tightening bottom hole, a first inner bottom threaded hole corresponding to the second outer bottom hole in which a female screw is cut, and a second inner bottom threaded hole corresponding to the first outer bottom hole in which a female screw is cut,
the bottom portion of the first beam includes a first beam inner bottom hole corresponding to the first outer temporary tightening bottom hole and a first beam outer hole corresponding to the first outer bottom hole and the second inner bottom threaded hole,
the bottom portion of the second beam includes a second beam inner bottom hole corresponding to the first inner temporary tightening bottom hole, and a second beam outer bottom hole corresponding to the first inner bottom threaded hole and the second outer bottom hole,
to couple the front portion of the first beam to the front portion of the second beam, the first inner front plate and the first outer front plate are temporarily tightened to the inner and outer sides of the front portion of the first beam through the first outer temporary tightening front hole, the temporary tightening front hole, and the first inner temporary tightening front hole with a first bolt and a first nut; a second bolt is screwed into the first inner front threaded hole, vertically arranged and temporarily tightened such that an end opposite to a head is externally located (This state is referred to as “first′ front state”); an end of the front portion of the first beam in the first′ front state contacts with an end of the front portion of the second beam; the first inner front threaded hole, the first front hole, and the first front hole are aligned, and after alignment, the end opposite to the head of the vertically arranged second bolt is pulled out to couple the front portions to each other with a second nut,
to couple the back portion of the first beam to the back portion of the second beam, the first inner back plate and the first outer back plate are temporarily tightened to the inner and outer sides of the back portion of the first beam through the first outer temporary tightening back hole, the temporary tightening back hole, and the first inner temporary tightening back hole with a third bolt and a third nut; a fourth bolt is screwed into the first inner back threaded hole, vertically arranged and temporarily tightened such that an end opposite to a head is externally located (This state is referred to as “first′ back state”); an end of the back portion of the first beam in the first′ back state contacts with an end of the back portion of the second beam; the first inner back threaded hole, the first back hole, and the first outer back hole are aligned; and after alignment, the end opposite to the head of the vertically arranged fourth bolt is pulled out to couple the back portions to each other with a fourth nut,
to couple the bottom portion of the first beam to the bottom portion of the second beam, the first outer bottom plate is temporarily tightened to the outer side of the bottom portion of the first beam through the first beam inner bottom hole and the first outer temporary tightening bottom hole with an eighth bolt and an eighth nut (This state is referred to as “first bottom state”); the first inner bottom plate is temporarily tightened to the inner side of the bottom portion of the second beam through the first inner temporary tightening bottom hole and the second beam inner bottom hole with a fifth bolt and a fifth nut; sixth and seventh bolts are screwed into the first inner bottom threaded hole and the second inner bottom threaded hole, respectively, vertically arranged and temporarily tightened such that an end opposite to a head is externally located (This state is referred to as “second bottom state”); an end of the bottom portion of the second beam in the second bottom state contacts with an end of the bottom portion of the first beam in the first bottom state; the first inner bottom threaded hole, the second beam outer bottom hole, and second outer bottom hole, and the second inner bottom threaded hole, the first beam outer bottom hole, and the first outer bottom hole are aligned; and after alignment, the ends opposite to the heads of the vertically arranged sixth and seventh bolts are pulled out to couple with sixth and seventh nuts, respectively; and contact portions of the upper portion of the first beam and the upper portion of the second beam are joined to each other by welding.

6. A beam junction method for connecting a hollow rectangular first beam having a rectangular cross section to a hollow rectangular second beam having a rectangular cross section,
wherein a portion of the first beam connecting to the second beam is a first inclined surface formed from a bottom portion of the first beam toward an upper portion of the first beam at A degrees (A<90) when viewed from front,
a portion of the second beam connecting to the first beam is a second inclined surface formed from a bottom portion of the second beam toward an upper portion of the second beam at B degrees (180 degrees−A degrees) when viewed from the front,
connection portions of a front portion of the first beam and a front portion of the second beam are sandwiched between a first inner front plate on an inner side and a first outer front plate on an outer side,
connection portions of a back portion of the first beam and a back portion of the second beam are sandwiched between a first inner back plate on the inner side and a first outer back plate on the outer side,
connection portions of the bottom portion of the first beam and the bottom portion of the second beam are sandwiched between a first inner bottom plate on the inner side and a first outer bottom plate on the outer side,
the first outer front plate includes a first outer temporary tightening front hole and a first outer front hole,
the first inner front plate includes a first inner temporary tightening front hole corresponding to the first outer temporary tightening front hole, a first inner front threaded hole corresponding to the first outer front hole in which a female screw is cut,
the front portion of the first beam includes a first front hole corresponding to the first outer front hole and the first inner front threaded hole, and the front portion of the second beam includes a temporary tightening front hole,
the first outer back plate includes a first outer temporary tightening back hole and a first outer back hole, the first inner back plate includes a first inner temporary tightening back hole corresponding to the first outer temporary tightening back hole and a first inner back threaded hole corresponding to the first outer back hole in which a female screw is cut,
the back portion of the first beam includes the first back hole corresponding to the first outer back hole and the first inner back threaded hole,
the back portion of the second beam includes a temporary tightening back hole,
the first outer bottom plate includes a first outer temporary tightening hole, a first outer bottom hole, and a second outer bottom hole,
the first inner bottom plate includes a first inner temporary tightening bottom hole, a first inner bottom threaded hole corresponding to the second outer bottom hole in which a female screw is cut, and a second inner bottom threaded hole corresponding to the first outer bottom hole in which a female screw is cut,
the bottom portion of the first beam includes a first beam inner bottom hole corresponding to the first outer temporary tightening bottom hole and a first beam outer hole corresponding to the first outer bottom hole and the second inner bottom threaded hole,
the bottom portion of the second beam includes a second beam inner bottom hole corresponding to the first inner temporary tightening bottom hole and a second beam outer bottom hole corresponding to the first inner bottom threaded hole and the second outer bottom hole,
to couple the front portion of the first beam to the front portion of the second beam, the first inner front plate and the first outer front plate are temporarily tightened to the inner and outer sides of the front portion of the second beam through the first outer temporary tightening front hole, the temporary tightening front hole, and the first inner temporary tightening front hole with a first bolt and a first nut; a second bolt is screwed into the first inner front threaded hole, vertically arranged and temporarily tightened such that an end opposite to a head is externally located (This state is referred to as “first front state”); an end of the front portion of the second beam in the first front state contacts with the front portion of the first beam; the first inner front threaded hole, the first front hole, the first outer front hole are aligned; and after alignment, the end opposite to the head of the vertically arranged second bolt is pulled out to couple the front portions to each other with a second nut,
to couple the back portion of the first beam to the back portion of the second beam,
the first inner back plate and the first outer back plate are temporarily tightened to the inner and outer sides of the back portion of the second beam through the first outer temporary tightening back hole, the temporary tightening back hole, and the first inner temporary tightening back hole with a third bolt and a third nut; a fourth bolt is screwed into the first inner back threaded hole, vertically arranged and temporarily tightened such that an end opposite to a head is externally located (This state is referred to as “first back state”); an end of the back portion of the second beam in the first back state contacts with an end of the back portion of the first beam; the first inner back threaded hole, the first back hole, and the first outer back hole are aligned, and after alignment, the end opposite to the head of the vertically arranged fourth bolt is pulled out to couple the back portions to each other with a fourth nut,
to couple the bottom portion of the first beam to the bottom portion of the second beam,
the first outer bottom plate is temporarily tightened to the outer side of the bottom portion of the first beam through the first beam inner bottom hole and the first outer temporary tightening bottom hole with an eighth bolt and an eighth nut (This state is referred to as “first bottom state”),
the first inner bottom plate is temporarily tightened to the inner side of the bottom portion of the second beam through the first inner temporary tightening bottom hole and the second beam inner bottom hole with a fifth bolt and a fifth nut; sixth and seventh bolts are screwed into the first inner bottom threaded hole and the second inner bottom threaded hole, vertically arranged and temporarily tightened such that an end opposite to a head is externally located (This state is referred to as “second bottom state”), respectively;
an end of the bottom portion of the second beam in the second bottom state contacts with an end of the bottom portion of the first beam in the first bottom state; the first inner bottom threaded hole, the second beam outer bottom hole, and the second outer bottom hole, and the second inner bottom threaded hole, the first beam outer bottom hole, and the first outer bottom hole are aligned; and after alignment, the ends opposite to the heads of the vertically arranged sixth and seventh bolts are pulled out and coupled with sixth and seventh nuts, respectively; and contact portions of the upper portion of the first beam and the upper portion of the second beam are joined to each other by welding.
